(19) United States
(12) Patent Application Publication
(10) Pub. No.: US 2014/0334421 A1
(43) Pub. Date: Nov. 13, 2014

(54) JOINT BIT LOADING AND SYMBOL ROTATION SCHEME FOR MULTI-CARRIER SYSTEMS IN SISO AND MIMO LINKS

(71) Applicant: Drexel University, Philadelphia, PA (US)

(72) Inventors: Guillermo Sosa, Montevideo (UY); Kapil R. Dandekar, Philadelphia, PA (US); Magdalena Bielinski, North Effort, PA (US); Kevin Wanuga, Philadelphia, PA (US)

(21) Appl. No.: 14/363,144

(22) PCT Filed: Dec. 7, 2012
(86) PCT No.: PCT/US12/68431

§ 371 Date: Jun. 5, 2014

Related U.S. Application Data
(60) Provisional application No. 61/567,939, filed on Dec. 7, 2011.

(51) Int. Cl. H04L 27/26; H04W 52/42; H04W 52/16; H04L 5/00

(52) U.S. Cl. CPC H04L 27/2618; H04L 5/0064; H04W 52/42; H04W 52/16
USPC 370/329

(57) ABSTRACT

The problems of high peak to average power ratio (PAPR) in multi-carrier systems and throughput improvement in multi-carrier systems by PAPR-aware rate adaptive bit loading are addressed by implementing two symbol rotation-inversion algorithms that reduce the peak to average power ratio in multi carrier OFDM systems jointly with rate adaptation. The method combines the benefits of bit allocation and symbol rotation to reduce the PAPR in OFDM communication systems and thus improve system range and robustness to noise. When coupled with adaptive bit loading techniques, these PAPR remediation strategies can substantially increase link throughput. Symbol rotation results in more than one order of magnitude BER reduction for SISO OFDM and one order of magnitude reduction in MIMO OFDM.

### CROSS REFERENCE TO RELATED APPLICATIONS

The present patent application claims priority to U.S. Provisional Patent Application No. 61/567,939 filed Dec. 7, 2011. The content of that patent application is hereby incorporated by reference in its entirety.

### GOVERNMENT RIGHTS

The subject matter disclosed herein was made with government support under award/contract/grant number CNS-0916480 awarded by the National Science Foundation. The Government has certain rights in the herein disclosed subject matter.

### TECHNICAL FIELD

The present invention relates to a data transmission system and method and, more particularly, to a data transmission system and method that employs joint bit-loading and symbol rotation in a multi-carrier transmission scheme so as to increase the average transmit power for the same peak transmit power to improve data rate and system robustness.

### BACKGROUND

Peak to average power ratio (PAPR) is a very well-studied topic in the communications field. Throughout the literature, diverse PAPR mitigation techniques have been proposed as high signal peaks result in significant performance degradation in OFDM. However, it is common to find solutions that address the implications of such techniques at the transmitter but do not consider how the PAPR mitigation actually improves the overall system performance. In general, non-linear distortions and out of band radiation at the transmitter are characterized, but the effect of reducing the PAPR at the receiver is omitted. The performance of PAPR remediation at the transmitter and receiver should be quantified to better understand overall system performance.

High PAPR has a detrimental effect on link average transmit power and transmission range. This occurs in implementations where the signal peak power is constrained and the OFDM signal is scaled before transmission. The motivation for PAPR remediation is to efficiently use the dynamic range of digital to analog converters and transmit amplifiers.

On the other hand, knowledge of the transmission channel can also improve system performance. It has been shown in the prior art that rate adaptive techniques in wireless channels allow for increased data rates. Some approaches reallocate power into sub-carriers where others just determine the optimal bit distributions while keeping the transmit power constant. Past research at the Drexel Wireless System Laboratory (DWSL) showed that adaptive bit-loading has great success in improving system throughput in slow fading and highly frequency selective channels. It will be shown that improved signal power at the receiver side contributes to better bit allocation distributions that outperform conventional schemes.

### SUMMARY

The invention provides a hardware implementation of how PAPR reduction techniques improve system performance as the average transmit power in SISO and MIMO OFDM communication systems is increased. Also, the invention provides a new scheme to minimize PAPR that makes use of bit allocation information and random symbol sequences. The way these PAPR reduction algorithms permute the symbols is such that it fits perfectly in the bit allocation framework, leading to a simple, but novel manner to reduce the PAPR in rate adaptive schemes. The solution is simulated for SISO and MIMO OFDM systems using 64 data sub-carriers. This solution opens the door for further improvements, such as techniques to reduce side information, simplified logic and optimal manners of scrambling symbols.

A system and method are provided for transmitting data in a multi-carrier transmission system that modulates the individual carriers independently and uses a peak-to-average power ratio reduction algorithm so as to increase the average transmit power for the same peak transmit power, thus improving bit-error rate performance. Such a system and method are different from existing peak-to-average power ratio reduction techniques because in that the invention is designed specifically for use in systems with carrier-dependent modulation. Also, the disclosed embodiments are different from existing carrier-dependent modulation techniques, also known as adaptive bit-loading algorithms, because it combines such techniques with peak-to-average power ratio reduction. As a result, the invention increases the average transmit power for the same peak transmit power and thereby decreases the probability of bit errors during transmission. The techniques of the invention provide improved results as the number of carriers in the multi-carrier transmission system increase. Practical applications of the invention may be used in ultra-wideband (UWB) systems or current wireless standards that employ 256 or more carriers.

In exemplary embodiments, the invention includes methods of transmitting data in a multi-carrier transmission system, comprising the steps of allocating transmission symbols to subcarrier frequencies, scrambling the transmit symbols after allocation simultaneously and successively finding a transmit sequence with a reduced peak to average power ratio, and transmitting the symbols of the transmit sequence with the reduced peak to average power ratio. Optionally, the subcarrier symbols may be interleaved for transmission in groups to modify the amount of symbol permutations. In operation, the searching step is repeated successively a predetermined number of times to find a transmit sequence that results in a minimum peak to average power ratio. The transmit sequence of scrambled symbols assigned to subcarriers are then selected to provide an increased transmit power over the transmit subcarrier frequencies.

The invention also includes a multi-carrier data transmission system for implementing the method to evaluate the peak to average reduction schemes of the invention. Such a system includes in an exemplary embodiment a processor that implements an adaptive bit loading algorithm to modulate symbols onto individual carriers at carrier frequencies independently and a processor that implements a peak-to-average-power ratio reduction algorithm to search the transmit carrier frequencies successively to find a transmit sequence with a reduced peak to average power ratio. A single input single output or multiple input multiple output transmitter is also provided that transmits the symbols on the transmit sequence of subcarriers with the reduced peak to average power ratio so as to increase an average transmit power for a same peak transmit power. In operation, the transmitter transmits symbols from the same symbol alphabets across different groups of carrier frequencies.

These and other novel features of the invention will become apparent to those skilled in the art from the following detailed description of the invention.

### BRIEF DESCRIPTION OF THE DRAWINGS

The various novel aspects of the invention will be apparent from the following detailed description of the invention taken in conjunction with the accompanying drawings, of which:

FIG. 1 illustrates division of the available bandwidth B into N flat subchannels Δf.

FIG. 2 illustrates FDMA sub-carrier spacing at (a) and OFDM sub-carrier spacing at (b)

FIG. 3 illustrates a conventional OFDM transceiver using fast Fourier transforms.

FIG. 4 illustrates a convention general OFDM transmission chain.

FIG. 5 illustrates OFDM PAPR reduction by means of random interleavers at the transmitter side.

FIG. 6 illustrates a MIMO OFDM PTS solution for PAPR reduction.

FIG. 7 illustrates a theoretical CCDF of the PAPR for a SISO OFDM system with 64, 128, 256 and 512 sub-carriers.

FIG. 8 illustrates a theoretical CCDF of the PAPR for a MIMO OFDM system with 64, 128, 256 and 512 sub-carriers.

FIG. 9 illustrates a CCDF of the PAPR for a simulated OFDM system of 48 data sub carriers when the SS-CSRI algorithm is implemented.

FIG. 10 illustrates a complexity comparison between optimal and sub-optimal rotation and inversion schemes for a single link scenario having M=10 divisions within an OFDM frame.

FIG. 11 illustrates a CCDF of the PAPR for a simulated MIMO OFDM system of 48 data sub carriers.

FIG. 12 illustrates a complexity comparison between optimal and sub-optimal rotation and inversion schemes for the 2×2 multiple link scenario.

FIG. 13 illustrates an adaptive Bit-loading implementation for an OFDM System.

FIG. 14 illustrates a proposed scheme in accordance with the invention for SISO OFDM at the transmitter side.

FIG. 15 illustrates a proposed scheme in accordance with the invention for SISO OFDM at the receiver side.

FIG. 16 illustrates a bit allocation example for an OFDM frame using 48 data sub-carriers.

FIG. 17 illustrates the allocated symbols over X₁ and X₂ where out of the 96 symbols, 82 sub-carriers are assigned BPSK symbols and 4-QAM are allocated to 8 sub-carriers and 16-QAM are allocated to 6 sub-carriers.

FIG. 18 illustrates a theoretical CCDF of PAPR for SISO and MIMO OFDM when random interleavers are used.

FIG. 19 illustrates PAPR reduction in accordance with the claimed invention for SISO OFDM and 64 sub-carriers.

FIG. 20 illustrates PAPR reduction in accordance with the claimed invention for MIMO OFDM and 64 sub-carriers.

FIG. 21 illustrates a WarpLab framework used for measurements in an exemplary embodiment of the invention.

FIG. 22 illustrates a channel emulator interference module user interface.

FIG. 23 illustrates an example hardware setup for single link measurements.

FIG. 24 illustrates a structure of an OFDM frame with 40 OFDM symbols for SISO OFDM over 64 sub-carriers.

FIG. 25 illustrates a structure of OFDM frames with 40 OFDM data symbols for MIMO OFDM over 64 sub-carriers at each of the transmit antennas.

FIG. 26 illustrates the first 180 samples of the real part of an OFDM frame before and after scaling.

FIG. 27 illustrates BER plots of an SISO OFDM using 64 sub-carriers and SS-CSRI algorithm and different numbers of total rotations.

FIG. 28 illustrates a scatter plot of sorted PPSNR for a SISO OFDM system with 64 sub-carriers and SS-CSRI algorithm implementation.

FIG. 29 illustrates histograms of scaling factors of original SISO OFDM system with 64 sub-carriers and system with SS-CSRI.

FIG. 30 illustrates the average received bits improvement achieved when rotating the transmit symbols in the SS-CSRI scheme.

FIG. 31 illustrates BER plots of an MIMO OFDM using 64 sub-carriers and SS-CARI scheme for M=4 and M=16.

FIG. 32 illustrates a scatter plot of ordered PPSNR values when the SS-CARI algorithm is implemented in a MIMO OFDM system with 64 sub-carriers for M=4 and M=16.

FIG. 33 illustrates scaling factor histograms of original MIMO OFDM system with 64 sub-carriers and system with SS-CARI. The left set of histograms correspond to antenna 1 and the right set to antenna 2.

FIG. 34 illustrates the average received bits improvement achieved when rotating the transmit symbols in the SS-CARI scheme.

FIG. 35 illustrates BER plots of an SISO OFDM using 64 sub-carriers and the scheme of the invention for NP=128.

FIG. 36 illustrates on the left a scatter plot of PPSNR improvement of the algorithm of the invention in SISO OFDM and 64 sub-carriers, while the right plot is a first order polynomial fit to the data.

FIG. 37 illustrates a percentage of allocated symbols at different PPSNR values in SISO OFDM for a 3 tap frequency selective channel.

FIG. 38 illustrates the average received bits improvement achieved when rotating the transmit symbols and performing bit allocation.

FIG. 39 illustrates scaling factor histograms of original SISO OFDM system with 64 sub-carriers and the scheme of the invention.

FIG. 40 illustrates BER plots of an MIMO OFDM using 64 sub-carriers and the scheme of the invention for NP=128.

FIG. 41 illustrates on the left a scatter plot of PPSNR improvement of the algorithm of the invention in SISO OFDM and 64 sub-carriers, while the right plot is a first order polynomial fit to the data.

FIG. 42 illustrates the percentage of bits allocated at each set of transmissions as a function of PPSNR.

FIG. 43 illustrates scaling factor histograms of original, rate adaptive, and the scheme of the invention in a MIMO OFDM system with 64 sub-carriers.

FIG. 44 illustrates the average received bits improvement achieved when rotating the transmit symbols and performing bit allocation.

### DETAILED DESCRIPTION OF ILLUSTRATIVE EMBODIMENTS

The invention will be described in detail below with reference to FIGS. 1-44. Those skilled in the art will appreciate that the description given herein with respect to those figures is for exemplary purposes only and is not intended in any way to limit the scope of the invention. All questions regarding the scope of the invention may be resolved by referring to the appended claims.

### Acronyms and Symbols

The following acronyms will have the indicated definitions when used in this document.

TABLE 1
Table of acronyms and definitions.

| Acronym | Definition |
|---|---|
| 3GPP | Third Generation Partnership Program |
| A/D | Analog-to-Digital |
| AWGN | Additive White Gaussian Noise |
| BER | Bit Error Rate |
| BPSK | Binary Phase Shift Keying |
| CARI | Cross Antenna Rotation & Inversion |
| CCDF | Complementary Cumulative Distribution Function |
| CDF | Cumulative Distribution Function |
| CFO | Carrier Frequency Offset |
| CP | Cyclic Prefix |
| CSRI | Cross Symbol Rotation & Inversion |
| D/A | Digital-to-Analog |
| DAB | Digital Audio Broadcasting |
| DVB | Digital Video Broadcasting |
| EVM | Error Vector Magnitude |
| FDMA | Frequency Division Multiple Access |
| FEC | Forward Error Correction |
| FFT | Fast Fourier Transform |
| GSM | Global System For Mobile Communications |
| ICI | Inter-Carrier Interference |
| IDFT | Inverse Discrete Fourier Transform |
| IFFT | Inverse Fast Fourier Transform |
| IPTS | Independent Partial Transmit Sequence |
| ISI | Inter-Symbolic Interference |
| LTE | Long Term Evolution |
| MEA | Multiple Element Antenna |
| MIMO | Multiple Input Multiple Output |
| O-CARI | Optimal-Cross Antenna Rotation & Inversion |
| O-CSRI | Optimal-Cross Symbol Rotation & Inversion |
| OFDM | Orthogonal Frequency Division Multiplexing |
| PAPR | Peak To Average Power Ratio |
| PPSNR | Post-Processing Signal-to-Noise Ratio |
| PTS | Partial Transmit Sequence |
| QAM | Quadrature Amplitude Modulation |
| SC-FDMA | Single Carrier Frequency Division Multiple Access |
| SF | Scale Factor |
| SISO | Single Input Single Output |
| SNR | Signal-to-Noise Ratio |
| SS-CARI | Successive Suboptimal-Cross Antenna Rotation & |
| | Inversion |
| SS-CSRI | Successive Suboptimal-Cross Symbol Rotation & |
| | Inversion |
| WARP | Wireless Access Research Platform |

The following symbols will have the indicated definitions when used in this document.

TABLE 2
Table of symbols and definitions.

| Symbol | Definition |
|---|---|
| tₖ | k^{th} sampling time |
| δ(t) | Kronecker Delta |
| N_{T} | Number of Transmit Antennas |
| N_{R} | Number of Receive Antennas |
| μ | Companding Parameter |
| α | Up-sampling Correction Factor |
| P_{avg} | Average Transmit Power |
| N | Number of Data Sub-carriers |
| M | Number of Divisions Per OFDM Symbol Block |
| S | Symbol Grouping Level Within Divided OFDM Symbol |
| | Block |
| Bᵢ | i^{th} Sub-Block of OFDM Symbols |
| [symbol] | j^{th} Permuted Version of the i^{th} Sub-Block of OFDM |
| | Symbols |
| Xi | Symbols to Send Over Antenna i |
| [symbol] | Best Permuted Symbols to Send Over Antenna i |
| X_{i,j} | j^{th} Complex Symbol to Send Over Antenna i |
| bₖ | Bits Allocated to k^{th} sub-carrier |
| N_{P} | Permutations Per Transmission |
| Pᵢ | Allocated sub-carriers for scheme i |
| Kᵢ | Scheme i Assigned Permutations |
| Kᵢₘₐₓ | Scheme i Maximum Permutations |
| Re (xₖ) | Real Component of Sampled OFDM Signal |
| Im (xₖ) | Imaginary Component of Sampled OFDM Signal |

### Overview of Orthogonal Frequency Division Multiplexing

Orthogonal Frequency Division Multiplexing (OFDM) dates back to the 1960s, but was not proposed to be used in wireless communications until the 1980s. Digital signal processing made possible the first OFDM hardware implementations in the early 1990s. In present times, many broadband communication schemes are based on OFDM. Among the most popular are wireless local area networks (WLANs), commonly known as 802.11a and 802.11g standards. Also, IEEE 802.16-2004/802.16e-2005 wireless metropolitan area networks and the Third Generation Partnership Program for Long Term Evolution (3GPP-LTE) standard make use of OFDM. Digital Audio Broadcasting (DAB) and Digital Video Broadcasting (DVB) applications are among other technologies based on OFDM.

In single carrier systems, small symbol durations make the channel response become extremely long and inefficient in terms of bandwidth utilization. For example, in the Global System for Mobile communications (GSM) standard, a bandwidth of 200 KHz is required to achieve data rates up to 200 kbit/s. On the other hand, sending data on parallel sub-carriers allows rates up to 55 Mbit/s in a 20 Mhz bandwidth (IEEE 802.11).

OFDM is a technology that allows for high throughput links by sending the data at lower rates on parallel narrowband channels. This makes it an attractive technology with the potential of handling high throughputs with limited complexity in environments where multi-path fading is present. Its simplicity lies in the trivial method of channel equalization. The frequency channel impulse response, Δf, encountered by each of the narrow band channels can be assumed to be flat with no need to apply complex equalization methods. For example, a channel of bandwidth B could be divided into N=B/Δf flat subchannels as shown in FIG. 1.

In an OFDM system, a stream of data is split into N parallel sub-streams with smaller data rates and modulated with different sub-carriers. The most important characteristic is that these N subcarriers must remain orthogonal along the entire transmission. If we denote each of the sub-carriers as fₙ=nB/N, where n is an integer and B is the total bandwidth, the symbol period can be defined as Tₛ=N/B. Therefore, if we assume for simplicity pulse amplitude modulation, is easy to see that within a symbol period, the integral of the product between modulated symbols at different sub-carriers is zero:

$${\int }_{0}^{{T}_{s}} {e}^{j2π {f}_{k} t} {e}^{- j2π {f}_{n} t} d t = 0 , for all k \neq n \qquad ( 1 )$$

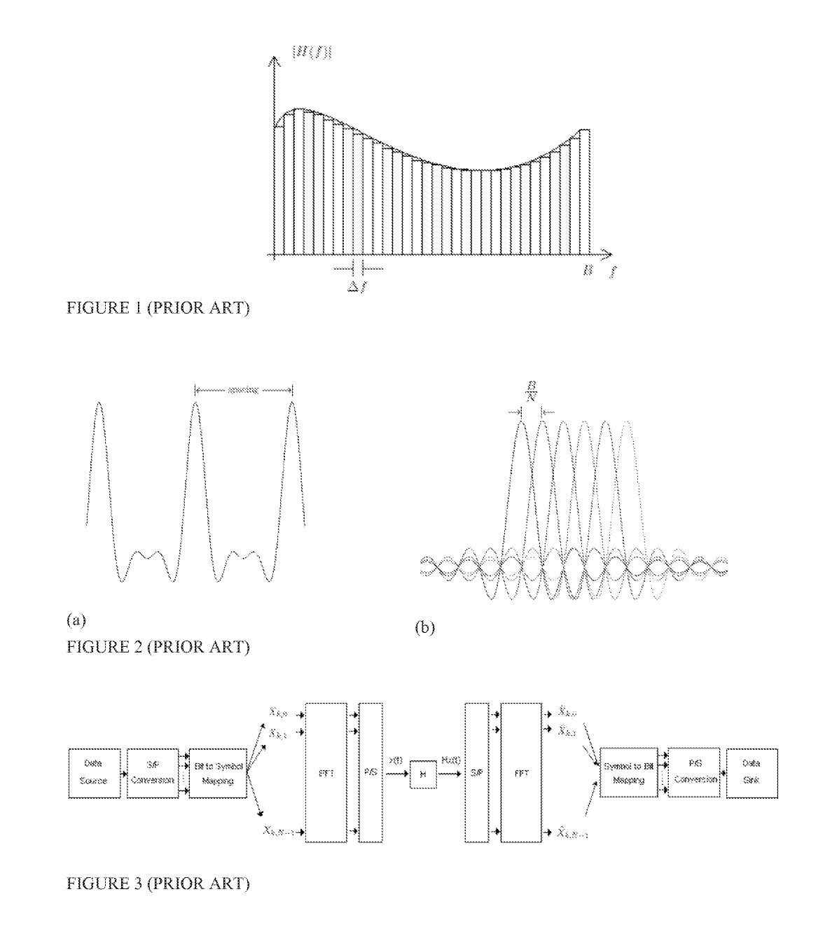

In the frequency domain, there is an overlapping of the sub-carriers spectra, but these overlaps occur in nulls of others, allowing the sub-carriers to be closer to each other and increase the bandwidth efficiency. On the other hand, conventional frequency division multiple access (FDMA) schemes waste a large amount of channel bandwidth as the spacing between sub-carriers is more significant, as shown in FIG. 2.

The blocks that generate, transmit, and receive an OFDM frame are described next. The transceiver structure of an end to end OFDM system in Additive White Gaussian (AWGN) channels is shown in FIG. 3. For these types of channels, the assumption is that the received symbols are only affected by AWGN noise and the channel can be represented by the Kronecker delta as:

$$δ ( t ) = \{ \begin{matrix}1 & t = 0 \\ 0 & for all t \neq 0\end{matrix} \qquad ( 2 )$$

First, serial bits from the Data Source block are converted into N parallel sub-streams. For each OFDM frame, bits of each sub-stream are mapped into N complex symbols Xₙe^{jφn} that are then fed to the Inverse Fast Fourier Transform (IFFT) block. The most general expression for the continuous time OFDM frame to be transmitted over the channel is given by:

$$x ( t ) = \frac{1}{\sqrt{{T}_{s}}} {\sum }_{i = - ∞}^{∞} {\sum }_{n = 0}^{N - 1} {X}_{i , n} {e}^{j ( 2 π n Δ ft + {φ}_{i , n} ) , 0 < t < {T}_{s}} \qquad ( 3 )$$

where i corresponds to instant of time, Δf=1/T_{S}, and T_{S} is the symbol period. Without losing generality and assuming i=0, the sampled version of x(t) at time instants tₖ=kT_{S}/N in equation (3) becomes:

$$x ( {t}_{k} ) = {x}_{k} = \frac{1}{\sqrt{{T}_{s}}} {\sum }_{n = 0}^{N - 1} {X}_{n} {e}^{j ( \frac{2 π nk}{N} + {φ}_{n} ) , 0 < k < N - 1} \qquad ( 3 )$$

Equation (4) is essentially the inverse discrete Fourier transform (IDFT) of the transmit symbols. The computationally efficient implementation of the IDFT is the IFFT, whose complexity increases as a function of log N instead of N. At the very end of the transmitter, a parallel to serial block is needed to sequentially send the N time domain samples from the output of the IFFT block into the channel.

The receiver logic is very similar to the transmitter for this type of channel. First, the received signal is sampled and converted into N parallel sub-streams. The samples are then fed to the FastFourier Transform (FFT) block and estimates of the transmitted symbols in the frequency domain, \tilde{X}ₙ, are created. The estimated symbols are mapped to bits and finally a parallel to serial conversion is done.

In a more realistic scenario, where multi-path is present and the channel becomes frequency selective, delay dispersion of the channel can lead to loss of orthogonality. Hence, different sub-carriers will start interfering with others, leading to what is known as inter-carrier-interference (ICI). A solution to this problem is to insert a guard interval in the OFDM frames known as the cyclic prefix (CP). These are dummy symbols appended to every OFDM symbol and are necessary to meet certain requirements described next.

The duration of the OFDM symbol TS is redefined to T_{S}=\hat{T}_{S}+T_{CP}, such that, during the period 0<t<T_{S}, the original OFDM frame is transmitted. Then, during the time −T_{CP}<t<0, the last symbols of the original frame are repeated. The symbols that are repeated are defined as the cyclic prefix. For a more formal definition, a new base function for transmission can be defined as:

$${g}_{n} ( t ) = {e}^{j2π n \frac{W}{N} t - {T}_{CP} < t < \hat{{T}_{S}}} \qquad ( 5 )$$

where W/N is the sub-carrier spacing and the original symbol period \hat{T}_{S}=N/W. From this definition, it is easy to see that

$${g}_{n} ( t ) = {g}_{n} ( t + \frac{N}{W } ) .$$

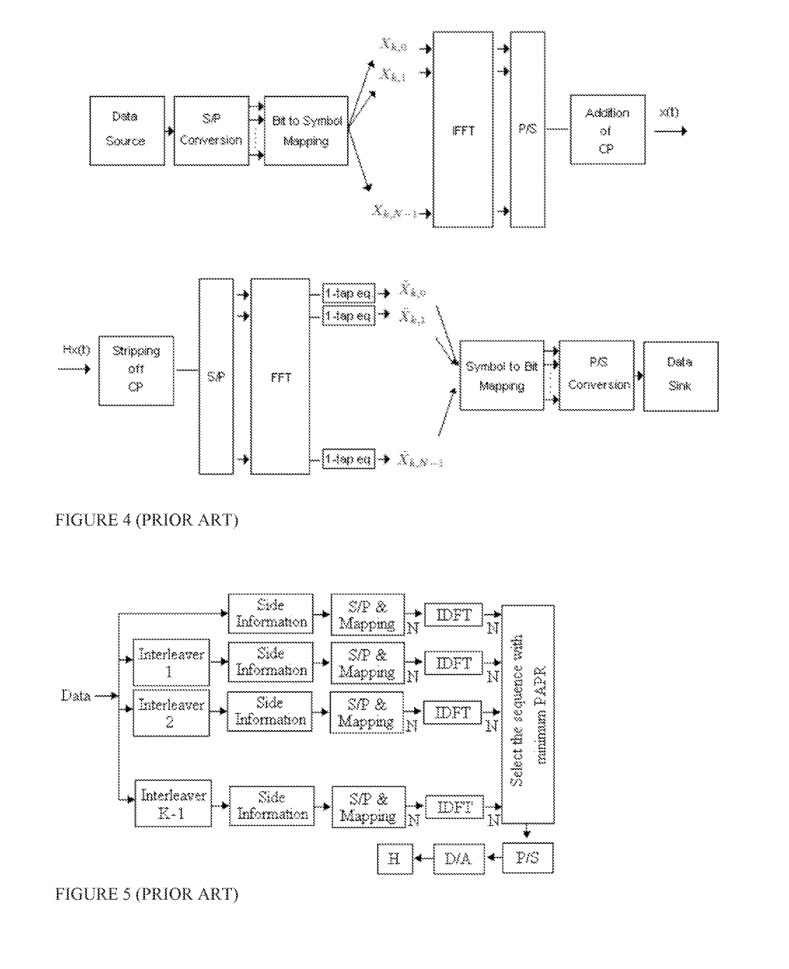

The CP is just a copy of the last part of the OFDM symbol and needs to be greater than the channel's maximum excess delay. Another important assumption is that the channel needs to be static during the transmission of an OFDM symbol. As we are discarding some part of the signal when introducing the CP, a loss in signal to noise ratio is expected; in general, 10% of the symbol duration is tolerable. Therefore, at the transmitter side, the CP is appended to the time domain symbols. At the receiver side, after the signal is sampled, the CP is stripped off and the remaining samples of the frame are taken into the frequency domain. One tap equalization is done to the frequency symbols to remove the channel effects at each of the sub-carriers. In FIG. 4, the general OFDM transmission chain incorporating the CP modules is shown.

### Peak to Average Power Ratio

The peak to average power ratio (PAPR) is one of the main disadvantages of Orthogonal Frequency Division Multiplexing (OFDM) systems. PAPR leads to a series of problems that consequently decreases system performance. The occurrence of high peaks comes from the nature of OFDM; independent streams at different sub-carriers can add up in phase, creating signal peaks which in the worst case scenario can be N times higher compared to the average power. These peaks do not occur often; however, when designing a communication system, it is a parameter that has to be taken into consideration.

For example, a consequence of high PAPR is the non-linear inter-modulation distortion among sub-carriers and out of band radiation. This occurs when the system amplifiers operate in their non-linear regions. A way to overcome this problem is to extend the amplifier's linear ranges. However, this results in costly devices. Another solution is to resort to other technologies similar to OFDM where PAPR is reduced; Single-Carrier FDMA (SC-FDMA) in the up-link is adopted in 3GPP-LTE as a solution to reduce the cost of amplifiers in mobile devices.

In general, a system with the potential of representing the OFDM signal with the available dynamic range to avoid signal clipping is desired. High signal peaks result in increased complexity of analog to digital (A/D) and digital to analog (D/A) converters. The solution to overcome this problem becomes necessary, but expensive.

Another problem that arises from high signal peaks is the reduction of the transmission range. In systems where the amplifier input back-off constrains the signal peak power, and whenever a peak occurs, the transmit signal power is reduced. This results in a reduced transmission range and increased bit error rate. The solution in this scenario is to increase the transmission power which results in very low efficiency.

Following the notation in the overview of OFDM above, the continuous time peak to average power ratio of a single link OFDM frame x(t) is defined as:

$$PAPR = {max}_{0 \leq t \leq {T}_{S}} \frac{{\vert x ( t ) \vert}^{2}}{E [ {\vert x ( t ) \vert}^{2} ]} \qquad ( 6 )$$

where E [•] is the expectation operator. Sampling at the Nyquist sampling rate is not enough to approximate the continuous PAPR of Equation (6). It has been shown that an oversampling factor of L=4 is necessary and sufficient to make an accurate approximation of the PAPR for digital signals. Therefore, the signal is sampled at tₖ=kT_{S}/(NL) and the oversampled time domain OFDM frame becomes:

$$\begin{matrix}x ( {t}_{k} ) = {x}_{k} \\ = \frac{1}{\sqrt{{T}_{s}}} {\sum }_{n = 0}^{N - 1} {X}_{n} {e}^{j ( \frac{2 π nk}{NL} + {∅}_{n} ) , 0 < k < NL - 1}\end{matrix} \qquad ( 7 )$$

The PAPR of the discrete oversampled OFDM frame is defined as:

$$PAPR = {max}_{0 \leq k \leq NL - 1} \frac{{\vert {x}_{k} \vert}^{2}}{E [ {\vert {x}_{k} \vert}^{2} ]} \qquad ( 8 )$$

Hence, to approximate the PAPR of a discrete OFDM data block X with N symbols, (L−1)N elements are zero padded to the data block and then an IFFT of size LN is performed.

### PAPR in MIMO OFDM

Multiple Input Multiple Output (MIMO) OFDM systems have been shown to improve the performance of communication systems in terms of throughput and robustness. These properties make MIMO OFDM an attractive technology that is at the core of next generation wireless communications. Also known as Multiple Element Antenna (MEA) systems, these can be used mainly for three different purposes: (i) beamforming; (ii) diversity; and (iii) spatial multiplexing. The first two aim to make more reliable transmissions by taking advantage of the scattered environment. When the transmitter has information about the channel, the transmit data vector is weighted/modified in such a way that the signal to noise ratio at the receiver is maximized. On the other hand, when channel information is not available to the transmitter, diversity techniques are implemented. In this light, the same data vector is sent more than one time through different streams to introduce spatial diversity. The last classification is a way to increase the throughput by sending multiple, independent, parallel streams of data. Several physical layers that rely on the multi-path and scatterers from the environment have been proposed in the prior art; however, MIMO OFDM is still OFDM and is sensitive to high PAPR in the same way as SISO OFDM links. High PAPR translates into a problem of each of the transmit antennas and needs to be addressed as well. The PAPR of MIMO OFDM systems can be defined as:

$${PAPR}_{MIMO} = {max}_{i = 1 , … , {N}_{T}} {PAPR}_{i} \qquad ( 9 )$$

where PAPRᵢ is the PAPR at transmit antenna i defined as in Equation (6) and N_{T} corresponds to the total number of transmit antennas.

### PAPR Mitigation

Within the literature PAPR is not a new concept. Several implementations seek to mitigate this problem in SISO and MIMO OFDM communication systems. Based on how algorithms address the PAPR problem, three main categories can be defined:
Signal Distortion Algorithms: The transmit signal is non-linearly distorted.
Forward Error Correction (FEC) codes: Refer to codes that exclude symbols that exhibit large peaks and are avoided in transmissions.
Data Scrambling: Implementations vary from data bit interleaving to symbol interleaving. Scrambled versions of the original data are generated and the one with the smallest PAPR is transmitted.
   When implementing such algorithms in MIMO OFDM, solutions to reduce the PAPR in SISO OFDM systems can be implemented on each transmit antenna separately. However, solutions to reduce the PAPR at all antennas include average PAPR minimization or maximum PAPR across streams minimization. A tradeoff between PAPR reduction, algorithm complexity and feedback information is the main concern for all implementations.

### PAPR Reduction Algorithm Examples

Signal Distortion

Among the proposed algorithms in this category, signal clipping and filtering is one of the most common and simple examples. In this scenario, whenever the signal peak amplitude exceeds a predetermined threshold it is clipped. Therefore, the amplitude of the transmitted signal gets distorted whenever a peak occurs and the phase remains unchanged. The signal to be transmitted, y(t), becomes:

$$y ( x ( t ) ) = \{ \begin{matrix}x ( t ) & if \vert x ( t ) \vert < A \\ {Ae}^{j∅ x ( ( t ) )} & if \vert x ( t ) \vert > A\end{matrix} \qquad ( 10 )$$

where φ(x(t)) corresponds to the phase of x(t) and A to the saturation threshold. Signal clipping becomes itself another source of signal distortion and therefore, filtering of the clipped signal needs to be done.

Another signal distortion technique that aims to reduce the PAPR is the companding technique. Particularly, it aims not to reduce the occurrence of peaks, but to increase the average transmit power. In this light, an invertible logarithmic function is applied at the transmitter and the time domain transmit signal becomes:

$$y ( x ( t ) ) = \frac{log ( 1 + μ \vert x ( t ) \vert )}{log ( 1 + μ )} sgn ( x ( t ) ) \qquad ( 11 )$$

where μ corresponds to the compression parameter and sgn to the sign function. At the receiver side the inverse operation is performed in the time domain and the received signal gets “expanded”. The main drawback of this solution is that in the expansion process, the system noise also gets expanded, increasing the bit error probabilities.

OFDM Coding

To establish the concept of OFDM coding, an example of a coding technique is presented below. Table 3 shows PAPR values for a four sub-carrier scheme for different codewords.

TABLE 3
Four sub-carrier PAPR values

| d₁ | d₂ | d₃ | d₄ | PAPR(W) |
|---|---|---|---|---|
| 0 | 0 | 0 | 0 | 16 |
| 1 | 0 | 0 | 0 | 7.07 |
| 0 | 1 | 0 | 0 | 7.07 |
| 1 | 1 | 0 | 0 | 9.45 |
| 0 | 0 | 1 | 0 | 7.07 |
| 1 | 0 | 1 | 0 | 16 |
| 0 | 1 | 1 | 0 | 9.45 |
| 1 | 1 | 1 | 0 | 7.07 |
| 0 | 0 | 0 | 1 | 7.07 |
| 1 | 0 | 0 | 1 | 9.45 |
| 0 | 1 | 0 | 1 | 16 |
| 1 | 1 | 0 | 1 | 7.07 |
| 0 | 0 | 1 | 1 | 9.45 |
| 1 | 0 | 1 | 1 | 7.07 |
| 0 | 1 | 1 | 1 | 7.07 |
| 1 | 1 | 1 | 1 | 16 |

From Table 3, it is easy to see that some sequences have a high PAPR, whereas some others do not. Hence, a coding scheme can be defined to avoid sending high PAPR sequences. It is evident that block coding 3-bit sequences into 4-bit sequences using an odd parity check bit determines a code word set without the sequences with high PAPR. However, this solution compromises transmission bandwidth, and has the drawbacks of poor scalability. In scenarios where more sub-carriers are used to convey data, it becomes more difficult to find the sequences that are not intended to be transmitted. Further, larger lookup tables to perform the coding and decoding are needed and the solution becomes impractical. More refined approaches are known where the benefits of error correction codes are also taken into account when finding the best code words to be transmitted. It has also been shown that the use of Golay complementary sequences and second order Red Muller codes can also achieve small PAPR values.

There are two other approaches than can be included in this category; the partial transmit sequences and the selective mapping techniques-both are quite similar in terms of implementation. The idea behind these approaches is to find different versions of the original sequence by first dividing the OFDM frame into sub blocks and applying different weights to each block. The weights would generate different block versions and the one with the smallest PAPR will be transmitted. In the first approach, operations are done in the time domain after the frames have been created, whereas in the selective mapping approach, the weighting is done in the frequency domain and the data frames are not sub divided. The performance of these approaches will be determined mainly by the amount of sub blocking and weight selection.

Data Interleaving

Data interleaving is one of the simplest approaches with promising results. In general, K−1 different versions of the original sequence are created and a total of K different sequences are compared. If the number of permutations is fixed, an exhaustive search would lead to the optimal sequence. However, this can become prohibitively complex for large number of permutations. Consider that for each of the sequences, an IFFT should be calculated in order to obtain the PAPR of that OFDM scrambled symbol, leading to a total of K IFFT computations. Therefore, it is important to design an algorithm that will achieve good PAPR reduction even if the search over different versions of the original sequence is not exhaustive.

For example, A. D. S. Jayalath and C. Tellambura present an adaptive scrambling scheme in “Peak-to-average power ratio reduction of an OFDM signal using data permutation with embedded side information,” In Circuits and Systems, 2001. ISCAS 2001. The 2001 IEEE International Symposium on, Volume 4, pages 562-565, Vol. 4, May 2001. When the PAPR of the j^{th} permuted sequence is below a specified threshold, the algorithm stops the search and selects that frame to send as shown in FIG. 5. Van Eetvelt, G. Wade, and M. Tomlinson propose a scheme in “Peak to average power reduction for OFDM schemes by selective scrambling,” Electronics Letters, 32(21):1963-1964, October 1996, to reduce the PAPR using selective scrambling and a selection criteria is based on Hamming weight and autocorrelation values. Two of the main algorithms that will be further described herein are based on the interleaving approach, but with the addition that the search is done in a successive way.

In the literature, it is also possible to find schemes that combine the benefits of more than one of the aforementioned approaches. H. Bakhshi and M. Shirvani present in “Peak-to-average power ratio reduction by combining selective mapping and golay complementary sequences,”. In Wireless Communications, Networking and Mobile Computing, 2009. WiCom '09. 5th International Conference on, pages 1-4, September 2009, the use of Golay sequences with selective mapping. G. Lin, Y. Shu-hui, and C. Yinchao present in “Research on the reduction of PAPR for OFDM signals by companding and clipping method,” In Wireless Communications Networking and Mobile Computing (WiCOM), 2010 6th International Conference on, pages 1-4, September 2010, a scheme that combines the companding function with signal clipping. Partial transmit sequences jointly with companding can be found in J. Kejin, Z. Xiaowei, and D. Taihang, “A fusion algorithm for PAPR reduction in OFDM system,” In Computational Intelligence and Industrial Applications, 2009. PACIIA 2009. Asia-Pacific Conference on, Volume 2, pages 216-219, November 2009.

MIMO OFDM Examples

As noted above, high PAPR in MIMO OFDM is an extension to the single antenna problem. Any of the aforementioned solutions can be applied to each transmit antenna, but the cost in complexity and side information grows proportionally with the number of transmit branches. On the other hand, multiple antennas introduce more degrees of freedom that can be accounted for to create better solutions.

In the literature, several solutions to the PAPR problem in MIMO OFDM already exist. An extension to selected mapping for MIMO OFDM is known that selects the set with the minimum maximum PAPR. In an article by X. Yan, W. Chunli, and W. Qi, “Research of peak-to-average power ratio reduction improved algorithm for MIMO-OFDM system,” In Computer Science and Information Engineering, 2009 WRI World Congress on, Volume 1, pages 171-175, Mar. 31, 2009-Apr. 2, 2009, the authors take advantage of space time block coding and a partial transmit sequence solution for MIMO OFDM is presented. In this scheme, the side information is reduced by half compared to the traditional independent partial transmit sequence (IPTS) scheme.

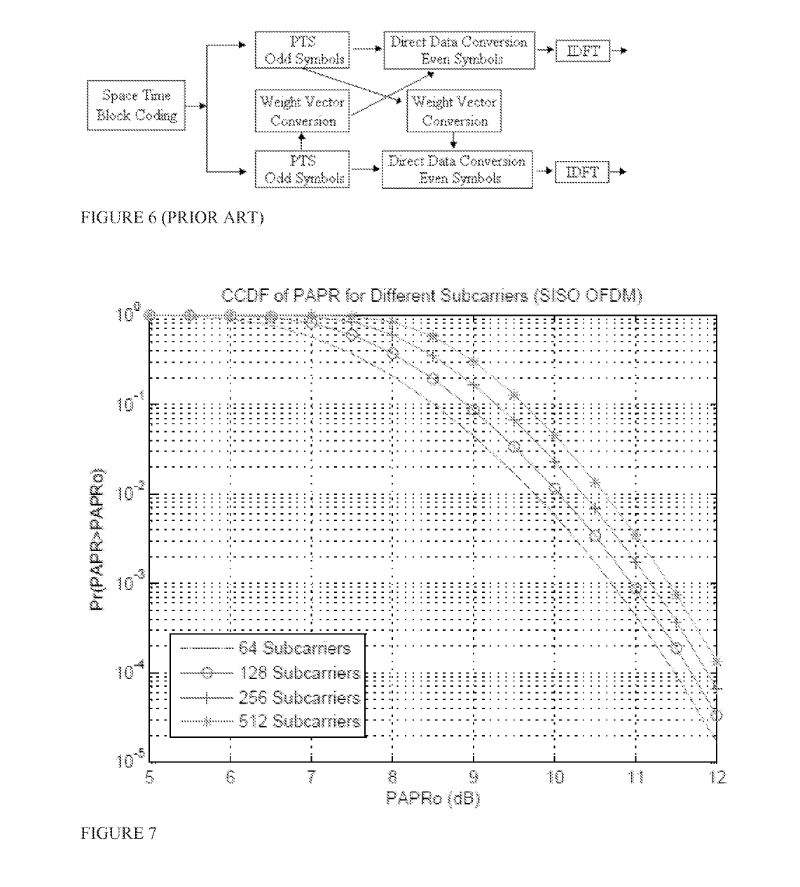

In FIG. 6, an example of the solution proposed by the authors is shown. In this scenario, the benefit comes from the fact that two OFDM sequences, X₁ and X₂, are such that X₁=−X*₂, and both sequences have the same PAPR. Therefore, the optimal weights for each of the sequences are also related. In this light, the search for the optimum weights does not need to go through all transmit symbols but only half. S. Suyama, H. Adachi, H. Suzuki, and K. Fukawa, propose in “PAPR reduction methods for eigenmode MIMO OFDM transmission,” In Vehicular Technology Conference, 2009. VTC Spring 2009. IEEE 69th, pages 1-5, April 2009, a PTS and selected mapping techniques in linear precoding MIMO OFDM where the channel state information is available to the transmitter.

### Selecting a PAPR Reduction Scheme

When selecting a technique, it is important to consider the implications entailed, not only the peak reduction potential. For example, signal distortion techniques are known for being very simple to implement, but generate non-linear distortions that increase the level of out of band radiation and result in increased BER. Moreover, signal clipping in the time domain is essentially a multiplication of an OFDM frame with a rectangular window (in the simplest case). In the frequency domain, this operation corresponds to a convolution of the spectrum of both components. In particular, the window spectrum has a very slow roll off factor and is responsible for the out of band radiation. In general, windows with good spectral properties are preferred. This is a highly studied area, but can lead to increased BER even though the PAPR is reduced.

Techniques such as coding and scrambling might need to convey side information so that the receiver can decode or deinterleave the information bits. Therefore, a tradeoff between PAPR remediation and available bandwidth becomes an issue. Another factor to consider is the computational complexity related with these algorithms. In general, signal distortion algorithms do not require a significant amount of computations. For example, in the companding approach, only a function has to be applied to the time domain signal with no added complexity. Even at the receiver, the inverse function is applied once and the side information would be only the compression parameter μ. On the other hand, in scrambling techniques several versions of the same transmit data need to be generated. The PAPR has to be computed and after those computations the data can be sent. If we set a large number of permutations, we will be able to achieve a good reduction at the expense of several, and sometimes prohibitive, computations. In Table 4, a summary of the different techniques is presented:

TABLE 4
Summary of general advantages and drawbacks among PAPR
mitigation techniques.

| | Advantage | Disadvantage |
|---|---|---|
| Signal Distortion | Simple, low computational | Additional noise |
| | complexity, no header | sources |
| | information | |
| OFDM Coding | High PAPR sequences not | Scalability, high |
| | sent, no header info | complexity |
| Symbol Interleaving | Simple, significant | Header information, |
| | improvement | Computational |
| | | Complexity |

### PAPR Statistics

The distribution of the PAPR as well as an upper bound are presented by A Vallavaraj, B. G. Stewart, and D. K. Harrison in “An evaluation of modified f-law companding to reduce the PAPR of OFDM systems,” AEU—International Journal of Electronics and Communications, 64(9):844-857, 2010. The direct dependence with the number of the system sub-carriers is shown below.

Distribution of the PAPR

Consider that each of the sub-carriers is a random variable, contributing to create the OFDM frame. From the central limit theorem, it follows that for a large number of sub-carriers, both the real and imaginary components of x(t) become Gaussian distributed, each of these with zero mean (μₓ=0) and variance σₓ=1/√2 (if unity transmit power is assumed). Therefore, the amplitude of the OFDM symbols becomes Rayleigh distributed and the power is characterized by a chi-square distribution with zero mean and two degrees of freedom. Its cumulative distribution function (CDF) is given by:

F(z)=1−e^{-z} (12)

In order to determine the CDF of the PAPR, under the assumption that samples are mutually independent and uncorrelated, the probability of the PAPR being smaller than a threshold for a N sub-carrier system can be written as:

Pᵣ(PAPR≦z)=F(z)^{N}=(1−e⁻z)^{N} (13)

From this expression, we can easily derive the complementary cumulative distribution function (CCDF) of the PAPR. This function represents the probability of the PAPR exceeding a threshold and is given by:

$$\begin{matrix}{P}_{r} ( PAPR > z ) = 1 - {P}_{r} ( PAPR \leq z ) \\ = 1 - {F ( z )}^{N} \\ = 1 - {( 1 - {e}^{- z} )}^{N}\end{matrix} \qquad ( 14 )$$

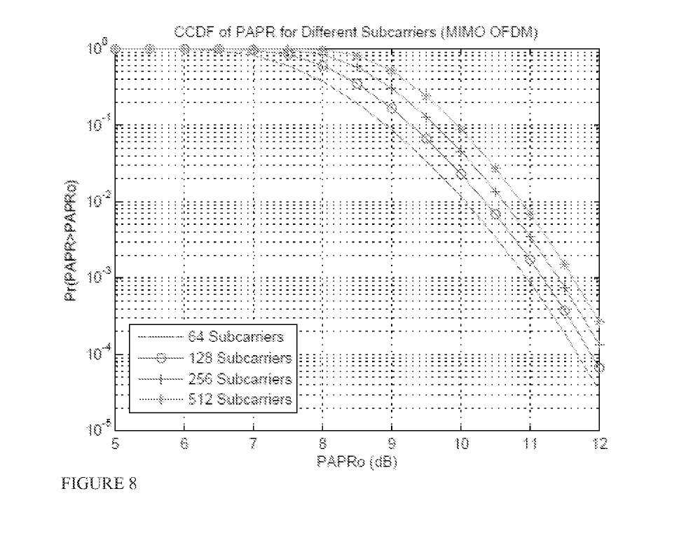

In FIG. 7, the CCDF of the PAPR is plotted for N=64; 128; 256 and 512 sub-carriers.

Clearly, the number of sub-carriers plays an important role when considering the effects of high PAPR in the communication system. For example, the probability of the PAPR being greater than a threshold is, in general, one order of magnitude greater using 512 sub-carriers when compared to 64 sub-carriers. Hence, communication systems that use a greater number of sub-carriers to convey information are more sensitive to the PAPR problem.

As was described above, the signal is oversampled in order to accurately approximate the continuous characteristics of the PAPR. In this context, the assumption of uncorrelated symbols no longer holds and a factor α is incorporated into Equation (13) to account for the oversampling. Therefore, the CCDF of the PAPR for oversampled frames becomes:

Pᵣ(PAPR>z)=1−(1−e^{-z})^{αN} (15)

where α≈2.8 gives a good approximation. Equation (15) will be the baseline for comparison with PAPR simulated values. For MIMO OFDM, the probability of the PAPR being greater than a threshold z across N_{T} antennas is given by:

$$\begin{matrix}{P}_{r} ( {PAPR}_{MIMO} > z ) = 1 - {P}_{r} ( {PAPR}_{MIMO} \leq z ) \\ = 1 - {F ( z )}^{{N}_{T} N} \\ = 1 - {( 1 - {e}^{- z} )}^{{N}_{T} N}\end{matrix} \qquad ( 16 )$$

Simulations of the PAPR CCDF in MIMO OFDM matched the expected theoretical approximation using the same correction factor α defined for SISO links. The corrected expression for the CCDF of the PAPR in MIMO OFDM systems is given by:

Pᵣ(PAPR_{MIMO}>z)=1−(1−e^{-z})^{αN}^{_{T}}^{N} (17)

The CCDF of the PAPR for MIMO OFDM is plotted in FIG. 8. It is evident that high PAPR is still a problem in multiple antenna communications when the number of sub-carriers is increased.

PAPR Upper Bound Derivation

In this section, we derive the maximum value of the PAPR in a multi-carrier system with N data sub-carriers when M-QAM and M-BPSK symbols are transmitted.

As described earlier, the inverse Fast Fourier Transform (FFT) is utilized to build the baseband representation of an OFDM symbol in the time domain as:

$$x ( t ) = {\sum }_{n = 0}^{N - 1} {X}_{n} {e}^{j ( 2 π n Δ ft + {∅}_{n} ) , 0 \leq t \leq NT} \qquad ( 18 )$$

where Xₙe^{jφn} is the n^{th} complex symbol to be sent, Δf=1/T, and T is the symbol period. The power across a 1Ω impedance can be found as:

$$\begin{matrix}P ( t ) = {\vert x ( t ) \vert}^{2} \\ = {\sum }_{n = 0}^{N - 1} {X}_{n}^{2} + 2 {\sum }_{n = 0}^{N - 2} {\sum }_{m = n + 1}^{N - 1} {X}_{n} {X}_{m} cos ( {∅}_{n} - {∅}_{m} + \frac{2 π ( n - m ) t}{N} )\end{matrix} \qquad ( 19 )$$

To find the average transmit power, we take the expectation of Equation (19):

$$\begin{matrix}{P}_{avg} = E [ {\vert x ( t ) \vert}^{2} ] \\ = E [ {\sum }_{n = 0}^{N - 1} {X}_{n}^{2} + 2 {\sum }_{n = 0}^{N - 2} {\sum }_{m = n + 1}^{N - 1} {X}_{n} {X}_{m} cos ( {∅}_{n} - {∅}_{m} + \frac{2 π ( n - m ) t}{N} ) ]\end{matrix} \qquad ( 20$$

Assuming the symbols to be independent and orthogonal, the second term of Equation (20) becomes zero and the total average transmit power becomes:

$${P}_{avg} = {\sum }_{n = 0}^{N - 1} {X}_{n}^{2} \qquad ( 21 )$$

From the PAPR definition and Equations 19 and 21, the analytical representation of the PAPR becomes:

$$PAPR = max \{ \frac{P ( t )}{{P}_{avg}} \} \\ PAPR = max \{ 1 + \frac{2}{{\sum }_{n = 0}^{N - 1} {X}_{n}^{2}} {\sum }_{n = 0}^{N - 2} {\sum }_{m = n + 1}^{N - 1} {X}_{n} {X}_{m} cos ( {∅}_{n} - {∅}_{m} + \frac{2 π ( n - m ) t}{N} ) \} \qquad ( 22 )$$

which represents the most general expression of the PAPR in OFDM. For M-PSK symbols, the average power, P_{avg}=N, and the maximum value that Equation (22) can achieve is:

$${PAPR}_{max} = \{ 1 + \frac{2}{N} \frac{N ( N - 1 )}{2} \} = N \to {PAPR}_{max} dB = 10 {log}_{10} ( N ) \qquad ( 23 )$$

This shows that there is a direct relationship between PAPR and the number of sub-carriers. The achievable reduction due to bit rotations will be addressed below.

### Data Permutation for PAPR Mitigation

In this section, two symbol rotation algorithms proposed by M. Tan and Y. Bar-Ness in “OFDM peak-to-average power ratio reduction by combined symbol rotation and inversion with limited complexity,” In Global Telecommunications Conference, 2003, GLOBECOM '03. IEEE, Volume 2, pages 605-610, Vol. 2, December 2003, and by M. Tan, Z. Latinovic, and Y. Bar-Ness in “STBC MIMO-OFDM peak-to-average power ratio reduction by cross-antenna rotation and inversion,” Communications Letters, IEEE, 9(7):592-594, July 2005. These algorithms are adapted for simulation in the environment that will also be used for measurements. The first scheme is proposed for SISO OFDM systems and the second is to be deployed in MIMO OFDM systems. The steps involved in generating different permuted sequences of symbols are also described. Optimal and suboptimal, but still promising, approaches are shown.

It has been shown that if the order of permutations to the transmit data is reduced, significant improvement in PAPR reduction can still be achieved. This motivates the implementation of suboptimal approaches, as the complexity of these type of implementations is an important limitation. The logic of these two schemes will be adopted in the proposed solution described below

Optimal Combined Symbol Rotation and Inversion

To describe the Optimal Combined Symbol Rotation and Inversion (O-CSRI) algorithm, consider a set of Xₙ, (0≦n≦N−1) complex symbols sent over N=48 data sub-carriers through a SISO OFDM communication system. Note that pilot symbols are not permuted. In this scheme, the sequence of symbols is divided into M sub blocks with N/M elements each. In this context, the i^{th} sub block is defined as

$${B}_{i} [ {X}_{i , 1} , {X}_{i , 2} , … , {X}_{i , \frac{N}{M}} ] .$$

Symbols within each block are then rotated in order to generate at most N/M different sub blocks: \tilde{B}ᵢ⁽¹⁾, \tilde{B}ᵢ⁽²⁾, . . . , \tilde{B}ᵢ^{(N/M)} where:

$$\begin{matrix}\begin{matrix}\begin{matrix}{\tilde{B}}_{i}^{( 1 )} = [ {X}_{i , 1} , {X}_{i , 2} , … , {X}_{i , \frac{N}{M}} ] \\ {\tilde{B}}_{i}^{( 2 )} = [ {X}_{i , \frac{N}{M}} , {X}_{i , 1} , … , {X}_{i , \frac{N}{M} - 1} ]\end{matrix} \\ ⋮\end{matrix} \\ {\tilde{B}}_{i}^{( \frac{N}{M} )} = [ {X}_{i , 2} , {X}_{i , 3} , … , {X}_{i , 1} ] .\end{matrix} \qquad ( 24 )$$

Another set of N/M sub blocks \tilde{B}ᵢ^{(j)} are generated by inverting the \tilde{B}ᵢ^{(j)}, sub blocks. Combining all these representations, we get a total of 2N/M blocks associated with the initial block. Hence, for a sequence of N symbols and M sub blocks, we can get at most (2N/M)^{M} different symbol combinations:

$$\begin{matrix}{\tilde{B}}_{i}^{( 1 )} = [ {X}_{i , 1} , {X}_{i , 2} , … , {X}_{i , \frac{N}{M}} ] & {\underline{{\tilde{B}}_{i}}}^{( 1 )} = [ - {X}_{i , 1} , - {X}_{i , 2} , … , - {X}_{i , \frac{N}{M}} ] \\ {\tilde{B}}_{i}^{( 2 )} = [ {X}_{i , \frac{N}{M}} , {X}_{i , 1} , … , {X}_{i , \frac{N}{M} - 1} ] & {\underline{{\tilde{B}}_{i}}}^{( 2 )} = [ - {X}_{i , \frac{N}{M}} , - {X}_{i , 1} , … , - {X}_{i , \frac{N}{M} - 1} ] \\ ⋮ & ⋮ \\ {\tilde{B}}_{i}^{( \frac{N}{M} )} = [ {X}_{i , 2} , {X}_{i , 3} , … , {X}_{i , 1} ] . & {\underline{{\tilde{B}}_{i}}}^{( \frac{N}{M} )} = [ - {X}_{i , 2} , - {X}_{i , 3} , … , - {X}_{i , 1} ] .\end{matrix} \qquad ( 25 )$$

As an example, an OFDM communication system using 64 sub-carriers (48 data sub-carriers) and M=24 sub blocks, a total of (2×48/24)²⁴≈2.81×10¹⁴ versions are possible for comparison. Therefore, the combination of symbols with the smallest PAPR is selected for transmission with the information of rotation and whether or not the symbol was inverted. Clearly, the implementation of the optimal approach is not feasible given the complexity and amount of computations needed to determine the best combination of symbols. Furthermore, in the case where more than one OFDM symbol is transmitted per frame, the amount of computations makes the approach even more complex.

As mentioned above, it has been shown that a suboptimal approach, where the permutations are done in a structured way, can still achieve significant improvements. This is the main motivation to define a sub optimal scheme-closely related, still able to achieve significant improvements with reduced amount of permutations.

Successive Suboptimal Combined Symbol Rotation and Inversion

In the successive suboptimal combined symbol rotation and inversion (SS-CSRI) algorithm, the manipulation of symbols is exactly the same as in the optimal approach but with the main difference that only a subset of permuted sequences are considered in the comparison process.

Consider a sequence of N complex symbols, Xₙ, (0≦n≦N−1), divided into M sub-blocks of N/M elements each. The symbol rotation and inversion for the first sub-block is performed to obtain a total of 2N/M combinations. Out of these combinations, the one that leads to the smallest PAPR is stored and combinations of subsequent M−1 sub blocks are not considered. We proceed to the next sub block and find the possible 2N/M combinations to compare. Again, the one that achieves the smallest PAPR is selected. All sub blocks are rotated successively and by the end of the main iteration a sequence with the best PAPR is determined

It is interesting to see that, in this approach, the PAPR is reduced gradually, whereas in the optimal approach, an extensive search is done in order to find the best combination. The total number of permutations reduces to

$${\underbrace{( \frac{2 N}{M} ) + ( \frac{2 N}{M} ) + … + ( \frac{2 N}{M} )}}_{M} = 2 N ,$$

which for an OFDM system with N=48 sub-carriers, reduces to only 96 combinations, independent to the number of divisions.

The number of permutations can be further reduced by creating subgroups of S elements within each of the M groups. Then, the rotation is done on a per subgroup basis instead of on a per symbol basis. This leads to a reduced number of N/(MS) different elements per sub-block and each of the Bᵢ will be expressed as:

$${B}_{i} = [ \underbrace{{X}_{i , 1} , … , {X}_{i , S} ,}_{1 st Group} \underbrace{{X}_{i , S + 1} , … , {X}_{i , 2 S}}_{2 nd group} , … , \underbrace{{X}_{i , ( \frac{N}{MS} - 1 ) S + 1} , … , {X}_{i , \frac{N}{M}}}_{{( \frac{N}{MS} )}^{th} group} ] \qquad ( 26 )$$

Therefore, the number of different representations is reduced to 2N/(MS) and the number of comparisons under this scheme is reduced to

$${\underbrace{( \frac{2 N}{MS} ) + ( \frac{2 N}{MS} ) + … + ( \frac{2 N}{MS} )}}_{M} = \frac{2 N}{S}$$

combinations.

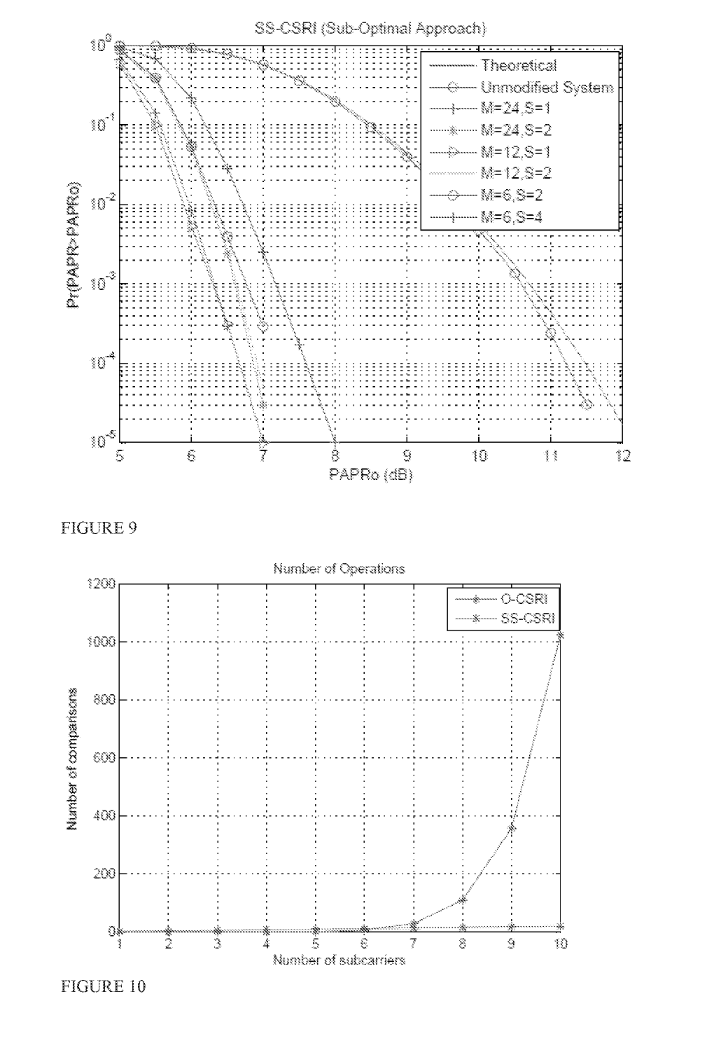

In FIG. 9, the probability of the PAPR being greater than a range of thresholds for the aforementioned algorithm is plotted. Different values of M and S set the amount of random sequences to compare. It is clear from FIG. 9 that the greater the amount of sub-blocks, the better the performance. Furthermore, by grouping the symbols into sub-blocks, there is a detrimental effect in most cases of around 2 dB. These curves are very close to the results presented for an OFDM system using 128 sub-carriers.

Side Information & Complexity

In terms of computational complexity, FIG. 9 shows clearly a trade-off between the number of operations to be done and the accuracy of the scheme. This sub-optimal approach compared to the optimal can still achieve good PAPR reductions and significantly reduce the number of operations (see FIG. 10). M. Tan and Y. Bar-Ness in “OFDM peak-to-average power ratio reduction by combined symbol rotation and inversion with limited complexity,” In Global Telecommunications Conference, 2003, GLOBECOM '03. IEEE, Volume 2, pages 605-610, Vol. 2, December 2003, also show that this approach outperforms the suboptimal PTS solution which has similar computational complexity making it an attractive option.

In the optimal algorithm, a total of (2N/M)^{M} comparisons are done and a total of M log₂(2N/M) bits are needed to correctly decode the symbols at the receiver. With the suboptimal approach, we saw that if the grouping parameter is set to one (S=1), the total number of comparisons reduces to 2N. However, in terms of side information the suboptimal approach needs the same amount of side information as the optimal approach.

Although the available permutations are reduced for each sub-block, the information of how many times the symbols were rotated as well as whether they were inverted or not needs to be conveyed. In fact, this overhead can become significant, motivating the use of random interleavers (known to both, transmitter and receiver) to create the permuted versions of the original frame. This is can eventually reduce the side information as well as the complexity of the entire scheme.

Optimal Cross Antenna Symbol Rotation and Inversion

The optimal cross antenna symbol rotation and inversion (I-CARI) approach addresses the PAPR in MIMO OFDM. The set of operations to find the optimal sequence is closely related to SISO OFDM and is described next. For the description, we consider a 2×2 MIMO OFDM system and an Alamouti physical layer. In this light, the set of symbols to be transmitted over N sub-carriers and two streams can be defined as: X₁=[X_{1,0}, X_{1,1}, . . . X_{1,N-1}] and X₂=[X_{2,0}, X_{2,1}, . . . X_{2,N-1}], where X_{i,j} corresponds to the j^{th} complex symbol in the i^{th} stream. The goal is to find two modified sequences, \tilde{X}₁ and \tilde{X}₂ such that the PAPR of the pair is minimized.

To determine the best sequences, each of the streams, Xᵢ, i=1, 2 is divided into M sub-blocks of N/M elements each. After grouping the symbols, each stream is represented as a collection of M subgroups: Xᵢ=[X_{i,0}, X_{i,1}, . . . , X_{i,M}], i=1; 2. Then, the symbol rotation and inversion is not done per stream but across antennas and for each of the M sub-blocks, 4 different combinations are generated. Next, an example of the 4 possible combinations obtained through rotating and inverting sub-block k is presented:

$${X}_{1} = {\underbrace{[ {X}_{1 , 1} , {X}_{1 , 2} , … , {X}_{1 , k} , … , {X}_{1 , M} ] {X}_{2} = [ {X}_{2 , 1} , {X}_{2 , 2} , … , {X}_{2 , k} , … , {X}_{2 , M} ] }}_{Original} \\ {{X}_{1} = [ {X}_{1 , 1} , {X}_{1 , 2} , … , {X}_{2 , k} , … , {X}_{1 , M} ] {X}_{2} = [ {X}_{2 , 1} , {X}_{2 , 2} , … , {X}_{1 , k} , … , {X}_{2 , M} ]}_{{}_{Subblock k Rotated}} \\ {{X}_{1} = [ {X}_{1 , 1} , {X}_{1 , 2} , … , {X}_{1 , k} , … , {X}_{1 , M} ] {X}_{2} = [ {X}_{2 , 1} , {X}_{2 , 2} , … , {X}_{2 , k} , … , {X}_{2 , M} ]}_{{}_{Original Subblock k Inverted}} \\ {{X}_{1} = [ {X}_{1 , 1} , {X}_{1 , 2} , … , {X}_{2 , k} , … , {X}_{1 , M} ] {X}_{2} = [ {X}_{2 , 1} , {X}_{2 , 2} , … , {X}_{1 , k} , … , {X}_{2 , M} ]}_{{}_{Subblock k Rotated and Inverted}} \qquad ( 27 )$$

If all possible combinations for all the M sub-blocks are considered, in a scenario where the data is transmitted over two antennas, the space of possible combinations has a total of

$$\underbrace{4 \cdot 4 \cdot 4 \cdot … \cdot 4}_{M} = {4}^{M}$$

elements. Out of these 4M combinations, the pair [\tilde{X}₁, \tilde{X}₂] with the smallest PAPR is selected to be transmitted.

When selecting the best sequence, a criterion to pick the best sequence needs to be defined. For example, in Y. L. Lee, Y. H. You, W. G. Jeon, J. H. Paik, and H. K. Song, “Peak-to-average power ratio in MIMO-OFDM systems using selective mapping,” Communications Letters, IEEE, 7(12):575-577, December 2003, the authors considered the average PAPR across links and selected the sequence with the smallest average PAPR. However, the approach presented by M. Tan, Z. Latinovic, and Y. Bar-Ness, in “STBC MIMO-OFDM peak-to-average power ratio reduction by cross-antenna rotation and inversion,” Communications Letters, IEEE, 9(7):592-594, July 2005, is followed in accordance with the invention. The best sequence is selected based on the maximum PAPR of the pair; for all the 4^{M} combinations, the maximum value of the PAPR is determined and the sequence that has the smallest maximum value is selected to be transmitted.

The selection of the physical layer was not random; in an Alamouti scheme, during the first symbol period, X₁ and X₂ are transmitted through antennas 1 and 2 respectively. At the next symbol period, −X*₂ is transmitted from antenna 1 and X*₁ from antenna 2. It is trivial to see that the PAPR of [−X*₂, X*₁] does not change with respect to the original sequences [X₁, X₂]. Therefore, the search for a sequence with reduced PAPR should be done only once. Also, side information which is sent in both streams, reaches the receiver side with higher reliability given the spatial diversity of the scheme.

For a SISO OFDM system with 48 data sub-carriers, considering M=16, a total of 4¹⁶=4.3×10⁹ combinations should be evaluated. If we account for the number of IFFT operations needed to compute the PAPR of the sequences, the amount is still prohibitively large. Therefore, this motivates a search of the best sequences in a suboptimal solution.

Successive Suboptimal Cross Antenna Symbol Rotation and Inversion

The Successive Suboptimal Cross Antenna Symbol Rotation and Inversion (SS-CARI) algorithm randomizes the complex symbols in the same way the CARI algorithm does. Given two streams X₁ and X₂ to be transmitted over two antennas, a division of M sub-blocks at each stream is done. As described above, four combinations of the pair are formed and the one that best complies with the selected criteria is retained. For the next sub-block, another four combinations, keeping subsequent sub-blocks unchanged, are evaluated. Performing these steps successively over the remaining subblocks and always keeping the best sequences, the set [\tilde{X}₁, \tilde{X}₂] is selected to be transmitted. In this algorithm the total number of combinations gets reduced to 4M.

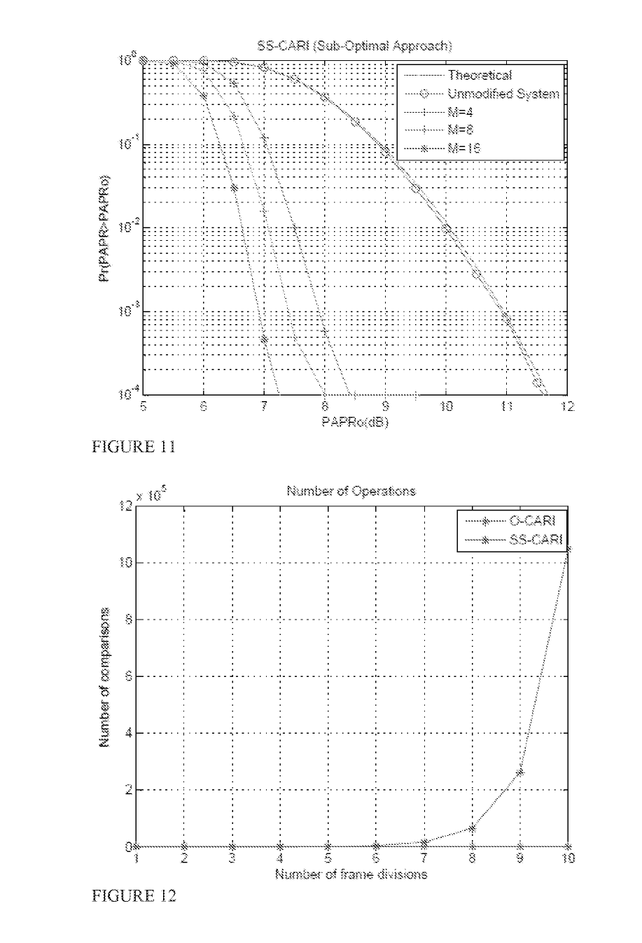

For example, a value of M=8 leads to a total amount of 4×8=32 combinations, which does not seem as enough to achieve a significant improvement. However, the successive characteristic of the algorithm make these 32 combinations approach a value close to the absolute minimum “faster” when compared to 32 random sequences. In FIG. 11, the CCDF for an OFDM system with 48 data sub-carriers is shown. These plots resemble the results presented by M. Tan, Z. Latinovic, and Y. Bar-Ness in “STBC MIMO-OFDM peak-to-average power ratio reduction by cross-antenna rotation and inversion,” Communications Letters, IEEE, 9(7):592-594, July 2005, where the algorithm is first proposed. At a probability of 10⁻³, there is an improvement of almost 4 dB when a value of M=16 is selected.

Side Information & Complexity

Similarly as in the single link scenario, making more divisions improves the system potential to reduce the PAPR; however, the trade-off between peak reduction, side information and complexity is present. The suboptimal scheme significantly reduces complexity but only when the number of sub divisions M is modified (see FIG. 12). It is shown by Tan, Latinovic, and Bar-Ness that this scheme outperforms concurrent SLM even with lower computational complexity.

The O-CARI approach needs a total of log₂(4^{M})=2M bits to convey the necessary information to correctly decode the received streams. The suboptimal approach creates only 4^{M} combinations against the 4^{M} of the optimal, but the side information amount is the same. This happens because, for each subset of symbols, it is still necessary for the receiver to know whether or not the symbol was rotated across the antennas and also if it was inverted.

### Rate Adaptation in OFDM

Rate adaptation in wireless channels for OFDM is a challenging, well studied field. In general, wireless standards such as the 802.11a/b/g define achievable throughputs for various combinations of a proposed number of symbols, coding and modulation rates. In most of these standards, the modulation rates are assumed to be the same across all data sub-carriers which, in reality, turns into suboptimal solutions in frequency selective channels. Channel state information at the receiver side allows the system to adapt to channel variations over time and different modulation orders across sub-carriers increases the system throughput considerably. However, this is not an easy task to perform, as the wireless medium changes rapidly and stale channel information might lead to either sub-carrier underload or overload of data. In general, channel estimation techniques require training symbols to first estimate the channel and then perform the bit allocation.

Within the literature, solutions to increase throughput in SISO and MIMO OFDM systems have been proposed and evaluated in software defined radios. The aim of the method of the invention is not to define a new allocation scheme, but to determine a baseline for easily characterizing the benefits of symbol rotation for these types of solutions. Therefore, a practical approach for rate adaptation in SISO OFDM systems has been adopted and extended to MIMO systems. The implemented allocation scheme may not represent the optimal solution for varying wireless channels, but provides an ideal framework to evaluate the performance of this type of scheme. In the next two sections, the adopted rate adaptive algorithms for SISO and MIMO OFDM are described.

Single Antenna Rate Adaptation

The core of the algorithm relies on the relationship between bit error probabilities and signal to noise ratios of different modulation schemes. This relationship is exploited in order to choose the modulation order that will make the system approach a target error probability. Equations that relate SNR, error rate and modulation order are used to determine the SNR ranges necessary for modulation orders M=2, 4, 16 and 64 achieve error rates from 10⁻⁶ to 10⁻⁴. Then, the per subcarrier signal to noise ratio is estimated and, with the aid of a look up table created from previous calculations, the number of bits to transmit over each of the sub-carriers are determined. M. Bielinski, K. Wanuga, R. Primerano, M. Kam, and K. R. Dandekar, in “Application of adaptive OFDM bit loading algorithm for high data rate through-metal communication,”. In Global Telecommunications Conference, 2011. GLOBECOM '11. IEEE, 2011 decide upon post processing SNR (PPSNR) instead of SNR due to practical issues. Very accurate results are presented even though there is not a direct relationship between SNR and PPSNR. In this solution, the same approach is followed and SNR is approximated from PP SNR.

To estimate the signal to noise ratio at the receiver, training sequences of 4-QAM symbols are sent every ten packets and the error vector magnitude per sub-carrier (EVM_{K}) is computed. Then, the signal to noise ratio at sub-carrier k is approximated by:

$${SNR}_{k} \approx \frac{1}{{EVM}_{k}^{2}} 1 <= k <= N \qquad ( 28 )$$

where N is the total number of data sub-carriers. Given the time varying wireless channel, every time the training sequence is sent, the SNRₖ is estimated and averaged with the previous estimate. Finally, the approximated SNRₖ value is used to search within the lookup table for bₖ, the maximum number of bits at sub-carrier k, that achieve an error rate within the specified range. Is important to notice that this is not a power scale rate adaptive scheme-it rather assumes uncorrelated bits and an average unit power. In Table 5, the actions taken at the training transmissions are summarized.

TABLE 5
SISO OFDM allocation process across data sub-carriers.

| Stage | Action |
|---|---|
| 1 | Approximate SNRₖ for k = 1 . . . N |
| 2 | Average SNRₖ of j^{th} training transmission with (j − 1) |
| | previous estimates |
| 3 | Mₖ selection such that 10⁻⁶ ≦ BER ≦ 10⁻⁴ for k = 1 . . . N |
| 4 | bₖ = log₂(Mₖ) for k = 1 . . . N |

Multiple Antenna Rate Adaptation

The allocation for 2×2 MIMO OFDM extends from the single link scheme and is also a practical implementation that shows the benefit of symbol rotation across antennas. The Alamouti physical layer was adopted to convey the data. Therefore, the same allocation at both transmit antennas is required. Having different allocations per stream would not allow the transmission order of symbols X₁ and X₂ first and then −X*₂ and X*₁ in the next time slot as it is defined.

The first step of the algorithm is to estimate the EVM at each of the received streams. Given the fact that a single stream is being sent in a redundant way, we rather look at the average EVM of the 2×2 MIMO system. In this sense, the received symbols are compared against the original stream of training symbols to determine the EVM at all sub-carriers after the symbol detection. This vector incorporates the distortion of symbols across the two antennas. Following the same approach as before, training sequences of 4-QAM symbols are sent every 10 packets to estimate the EVM and at every training frame, the new EVM is averaged with the previous estimates. In between training sequences, the allocation is maintained.

In this light, the SNRₖ is found using Equation 28 and look up tables relating signal to noise ratios, error rates and modulation orders are used to allocate bits. After the allocation is performed, the symbols are sent over the two antennas without any conflict with the implemented physical layer.

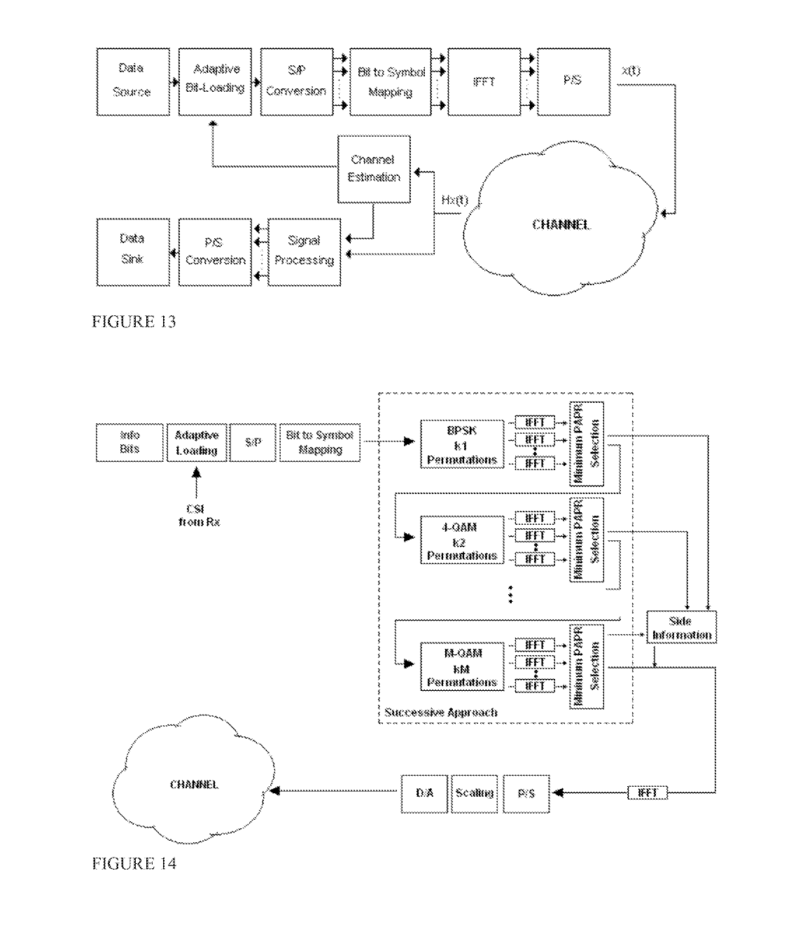

Although suboptimal in varying wireless channels, simulations showed that this approach is sufficient to allocate symbols outperforming fixed rate transmissions and provides the perfect framework to evaluate the proposed PAPR reduction scheme set forth below. The adaptive bit-loading scheme for OFDM is shown in FIG. 13.

### Rate Adaptive and Symbol Rotation Algorithm

Given the previous definitions for rate adaptation and symbol rotation, a new scheme that merges the benefits of these techniques is presented in accordance with the invention. The idea is simple but novel, providing a robust system that adapts to channel conditions and symbols with reduced PAPR. The proposed algorithms for SISO and MIMO OFDM systems are described below. The achievable improvement in PAPR reduction will be shown by means of CCDF simulations. A notion of how rotations can improve the system performance is also addressed and compared to the fixed rate proposed schemes presented above.

SISO OFDM Bit Allocation and Symbol Rotation

Notation

In the single link scenario, the initial step is to allocate bits to sub-carriers following the description above. Then, the total number of permutations per transmission will be set to a fixed number N_{P}. Symbols will be permuted in the frequency domain by means of random interleavers and, for each symbol, no more than N_{P} different versions will be generated. We are going to use i to index the modulation schemes where i=1, 2, . . . , M and Pᵢ to the number of allocated sub-carriers for scheme i.

Permutations Per Scheme

For an allocation of M modulation schemes, the rule will be that symbols allocated in sub-carriers with modulation order i will be permuted Kᵢ=N_{P}/M times. The initial approach is to be fair with all schemes in the sense that, if there are M different schemes, all will be permuted the same number of times.

The cardinal of symbols, Pᵢ, allocated to sub-carriers needs to be taken into account as it may represent a limitation to achieve maximum diversity. In other words, it may not be possible to find Kᵢ different combinations for scheme i; henceforth, another action needs to be taken. We are going to define the maximum bound of possible permutations of symbols from scheme i as Kᵢₘₐₓ=Pᵢ!. This quantity will determine the amount of permutations that will be performed on this scheme. Also, it should hold that Σᵢ₌₀^{M}Kᵢ=N_{P}. Therefore, the remaining permutations needed to achieve N_{P} will be equally redistributed between the remaining schemes.

In this light, the algorithm will start assigning the value Kᵢ to the scheme which has the smallest number of allocated sub-carriers. Based on the upper bounds, Kᵢₘₐₓ, of all the schemes, it will be determined whether or not equal rotation can be assigned. Then, it will continue with the remaining schemes gradually, until the scheme with the highest amount of allocated sub-carriers is reached.

Data Permutation Process

After the rotations per scheme are determined, the CSRI approach is followed; sequences with the smallest PAPR are found successively. When the best sequence for scheme i is found, it is stored and permutations of subsequent symbols will account for this information. In Table 6, the procedure to determine the sequence with the best PAPR properties in a successive manner is summarized:

TABLE 6
Summary of steps to determine the sequence with the minimum PAPR.

| Stage | Action |
|---|---|
| 1 | Fix Nₚ. Adaptive Bit Loading determines the number of |
| | modulation schemes, M. |
| 2 | Determine the number of subcarriers for each modulation order, |
| | Pᵢ; i = 1, 2, . . . , M. Sort the Pᵢ in ascending order. |
| 3 | For i = 1, 2, . . . , M − 1, determine Kᵢₘₐₓ = Pᵢ |
| 4 | $If {K}_{imax} \geq \frac{{N}_{p}}{M - i + 1} - {\sum }_{j = 1}^{i} {K}_{jmax} \text{:}$ |
| | $a ) Set {K}_{imax} = \frac{{N}_{p}}{M - i + 1} - {\sum }_{j = 1}^{i} {K}_{jmax}$ |
| | b) Otherwise, Kᵢₘₐₓ = Pᵢ! |
| 5 | $\begin{matrix}Finally , {K}_{Mmax} = {N}_{p} - {\sum }_{i = 1}^{M - 1} {K}_{imax} \\ such that \\ {\sum }_{i = 1}^{M} {K}_{imax} = {N}_{p}\end{matrix}$ |
| 6 | Nₚ permutations with random interleavers are performed. |
| 7 | Sequence with minimum PAPR is determined successively. |

The logic of the proposed system is shown in FIG. 14. After symbols of each scheme are permuted and an optimal sequence is found, the information of which interleaver yielded these sequences is sent to the side information block. At the end of the process, all the information of interleavers is inserted to the OFDM frame. Before being sent into the channel, the frame is scaled in order to use all the dynamic range of the D/A converter. At this stage, the PAPR minimization plays an important role. The sequence to be sent will have an increased transmit power and will result in reduced BER and improved performance.

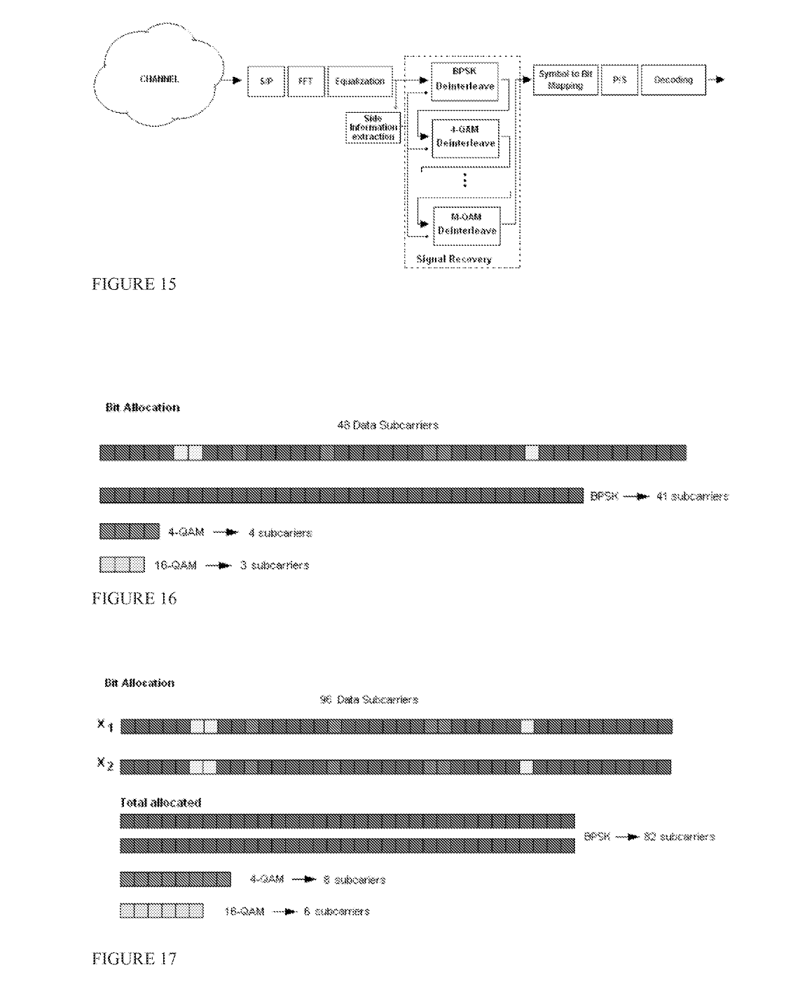

At the receiver, the original sequence needs to be recovered. Using the side information, the original sequence is found successively, deinterleaving each set of symbols on a per scheme basis. After all the symbols are placed into their original allocations, the symbol to bit mapping takes place and finally the original bits are decoded as shown in FIG. 15.

Side Information & Complexity

In terms of complexity, the proposed scheme of the invention will only create a total of N_{P} comparisons independently of the total number of subcarriers as in the SS-CSRI scheme. Regarding side information, the number of rotations N_{P} will determine how many bits are needed to convey the information. Under the assumption that the seeds of the interleavers are known to transmitter and receiver, the total number of bits needed to correctly decode the data will be M log₂ (N_{P}/M). In other words, it is important to send the information of which seed/interleaver leaded to the minimum PAPR at each of the frame subblocks. Compared to the SS-CSRI, the number of side information bits can be upper bounded by the user if information about the maximum number of modulation orders is available.

The proposed scheme of the invention can be thought as the SS-CSRI scheme with a variable number of symbol divisions M and, therefore, one would think that more side information should be inserted. However, this information is known given the fact that any underlying bit-loading algorithm will already provide the placement of the bits which will become the actual division of symbols.

Numerical Example—SISO Solution

To demonstrate the proposed scheme of the invention, we provide an example that determines the total number of rotations per scheme, assuming a total number of rotations, N_{P}=90, and a real allocation scenario. In FIG. 16, a bit allocation example for an OFDM frame using 48 data sub-carriers is shown. In this frame, of the 48 data sub-carriers, BPSK symbols were allocated to 41 carriers, 4-QAM to 4 and 16-QAM symbols were placed only on 3 sub-carriers. At the first stage, for N_{P}=90 permutations, 30 will be initially assigned per scheme given that M=3. However, for these schemes, we will determine the information shown in Table 7.

TABLE 7
Initial mapping between modulation orders,
permutations and maximum bounds.

| i | Modulation | Pᵢ | Kᵢₘₐₓ |
|---|---|---|---|
| 1 | 16-QAM | 3 | 6 |
| 2 | 4-QAM | 4 | 24 |
| 3 | BPSK | 41 | 41! |

In this case, K₁, K₂ and K₃ cannot be assigned the same value. Therefore, the number of rotations will be constrained by Kᵢₘₐₓ. For such allocation, 16-QAM has K₁ₘₐₓ=6 which translates into K₁=6. The remaining 90−6=84 will be equally mapped to 4-QAM and BPSK schemes. Then, 84/2=42 permutations are mapped to 4-QAM and BPSK but the same problem arises; only K₂ₘₐₓ=24 combinations of 4-QAM are possible, so K₂=24. Finally, the remaining permutations 90−24−6=60 are assigned to the BPSK symbols and K₃=60. Table 8 summarizes the steps to determine the amount of rotations to perform on each modulation scheme.

TABLE 8
Process to determine the amount of rotations when
allocated sub-carriers are a limitation.

| Stage | 16-QAM | 4-QAM | BPSK |
|---|---|---|---|
| 1 | 30 > K₁ₘₐₓ | 30 > K₂ₘₐₓ | 30 |
| 2 | K₁ = 6 | (90 − 6)/2 = 42 > K₂ₘₐₓ | (90 − 6)/2 = 42 |
| 3 | K₁ = 6 | K₂ = 24 | 90 − 6 − 24 = 60 |
| 4 | K₁ = 6 | K₂ = 24 | K₃ = 60 |

By the end of the process, 6 combinations of 16-QAM symbols will be generated and the best will be retained. Next, 24 combinations of 4-QAM symbols will be compared considering the best combination of 16-QAM symbols. Finally, 60 combinations of BPSK symbols are compared selecting the sequence with the smallest PAPR.

MIMO OFDM Bit Allocation and Symbol Rotation

For multiple link systems, we assume the same physical layer described in the CARI section, an Alamouti 2×2 MIMO OFDM system. The logic of the solution in this scenario will resemble the single link case with more degrees of freedom. The algorithm will initially allocate bits onto different sub-carriers as stated above under the condition that both antennas have the same bit allocation, as different allocations per antenna are not compatible with the Alamouti scheme. Symbols will be rotated and inverted across streams and the number of permutations per transmission will be fixed to N. In this light, a total of N_{P} different pairs of the original sequences X₁ and X₂ will be generated and compared to find the one with the best PAPR properties. Next, a more detailed description of the algorithm is provided. The notation introduced above will be followed.

Data Permutation Process

The first step of the algorithm is to determine the schemes that have been allocated across data sub-carriers. Then, the symbols will be rotated and inverted across streams under the condition that symbols assigned to a set of sub-carriers will be rotated and inverted across the same set of sub-carriers. The symbol grouping will be implicitly determined in the allocation process and it is important to notice that these groups are not going to be formed by contiguous sub-carriers. In fact, symbols of a certain scheme will be spread across the 48 data sub-carriers. To generate the N_{P} permuted pairs, the data is serialized to create a single stream Y with twice the number of symbols, after symbols have been assigned to all the sub-carriers.

$$\begin{matrix}{X}_{1} = [ {X}_{1 , 0} , {X}_{1 , 1} , … , {X}_{1 , N - 1} ] \\ {X}_{2} = [ {X}_{2 , 0} , {X}_{2 , 1} , … , {X}_{2 , N - 1} ]\end{matrix} \} ⇒ Y = [ {X}_{1 , 0} , {X}_{1 , 1} , … , {X}_{1 , N - 1} , {X}_{2 , 0} , {X}_{2 , 1} , … , {X}_{2 , N - 1} ]$$

In this vein, the procedure described above is applied to this new stream of length 2N and N_{P} versions Y^{j}, j=1 . . . N_{P} become available. Then, the data is converted to parallel streams in order to create the N_{P} different pairs.

$$\begin{matrix}\begin{matrix}\begin{matrix}\begin{matrix}{Y}^{1} \\ {Y}^{2}\end{matrix} \\ ⋮\end{matrix} \\ {Y}^{{N}_{p} - 1}\end{matrix} \\ {Y}^{{N}_{p}}\end{matrix} \} ⇒ \begin{matrix}\begin{matrix}\begin{matrix}\begin{matrix}\begin{matrix}\begin{matrix}{X}_{1}^{1} \\ {X}_{2}^{1}\end{matrix} \\ {X}_{1}^{2}\end{matrix} \\ {X}_{2}^{2}\end{matrix} \\ ⋮\end{matrix} \\ {X}_{1}^{{N}_{p}}\end{matrix} \\ {X}_{2}^{{N}_{p}}\end{matrix} \} ⇒ \begin{matrix}{\tilde{X}}_{1} = [ {\tilde{X}}_{1 , 0} , {\tilde{X}}_{1 , 1} , … , {\tilde{X}}_{1 , N - 1} ] \\ {\tilde{X}}_{2} = [ {\tilde{X}}_{2 , 0} , {\tilde{X}}_{2 , 1} , … , {\tilde{X}}_{2 , N - 1} ]\end{matrix} \qquad ( 29 )$$

As shown in FIG. 14, The pair \tilde{X}₁, \tilde{X}₂ with minimum PAPR is chosen to be transmitted. To find the best sequence, the search is done across all present modulation orders successively and retaining the best sequences.

Side Information & Complexity

The complexity of the scheme of the invention is very similar to the single link scenario. Even though it should take twice the resources to find the best sequences, using the Alamouti physical layer allows the scheme to reduce the computations by half (recall that the PAPR properties of the pair X₁ and X₂ are the same as the pair −X*₂ and X*ᵢ). Similar to the SISO solution, under the assumption that the vector to randomize the sequences is known to both transmitter and receiver, the number of bits necessary to recover the data at the receiver is M log 2 (N_{P}/M). This implies that the receiver will have information of what seed yielded the minimum PAPR at different subgroups.

Next, an example for MIMO OFDM using 48 data sub-carriers and the allocation presented above is analyzed.

Numerical Example—MIMO Solution

Assume a total of N_{P}=90 permutations and that allocations occur across 48 data sub-carriers. FIG. 17 shows the allocated symbols over X₁ and X₂, where out of the 96, 82 sub-carriers are assigned BPSK symbols, 4-QAM to 8 sub-carriers and 16-QAM were allocated 6 sub-carriers. Similarly to the SISO scenario, in the first stage, 30 rotations will be assigned to each scheme. However, given the fact that there are more sub-carriers assigned to each scheme (in comparison to SISO), in general Kᵢₘₐₓ will not be a constraint. In Table 9, Kᵢₘₐₓ values for different modulation orders are shown.

TABLE 9
Initial mapping between modulation orders,
permutations and maximum bounds.

| i | Modulation | Pᵢ | Kᵢₘₐₓ |
|---|---|---|---|
| 1 | 16-QAM | 6 | 720 |
| 2 | 4-QAM | 8 | 4032 |
| 3 | BPSK | 82 | 82! |

The algorithm next determines the number of rotations per scheme without any limitation. Finally, for this example, K₁=K₂=K₃=30 and the symbols of the schemes are rotated the same number of times.

PAPR Reduction Capabilities

In this section we analyze the performance of the proposed algorithms of the invention in terms of achievable PAPR reduction. To do this, the CCDF of the PAPR is studied in a manner similar as that described above. However, an analytical expression for interleaved OFDM frames is presented first.

Analytical PAPR CCDF of Interleaved OFDM

Following the derivation by A. D. S. Jayalath and C. Tellambura in “Use of data permutation to reduce the peak-to-average power ratio of an OFDM signal,” In Wireless Communications and Mobile Computing, Volume 2, pages 187, 203, 2002, the CCDF of the PAPR using K random interleavers can be obtained as:

$${P}_{r} ( {PAPR}_{interleaved} > z ) = {\prod }_{i = 1}^{K} {P}_{r} ( {PAPR}_{i} > z ) \qquad ( 30 )$$

where (PAPRᵢ>z) is the probability associated to the signal being interleaved by interleaver “i”. Under the assumption that all the randomized versions are independent and uncorrelated, Equation (30) becomes:

Pᵣ(PAPR_{interleaved}>z)=Pᵣ(PAPR>z)^{K} (31)

Hence, from Equations (15) and (31) we can easily derive the CCDF of the PAPR using K interleavers as:

Pᵣ(PAPR_{interleaved}>z)=[1−(1−e^{-z})^{αN}]^{K} (32)

A similar approach can be considered to derive the CCDF of the PAPR in MIMO OFDM using K random interleavers. In this case, using Equations (16) and (31) the CCDF is given by:

Pᵣ(PAPR_{MIMO}_{_{—}}_{interleaved}>z)=[1−(1−e^{-z})^{αN}^{_{T}}^{N}]^{K} (33)

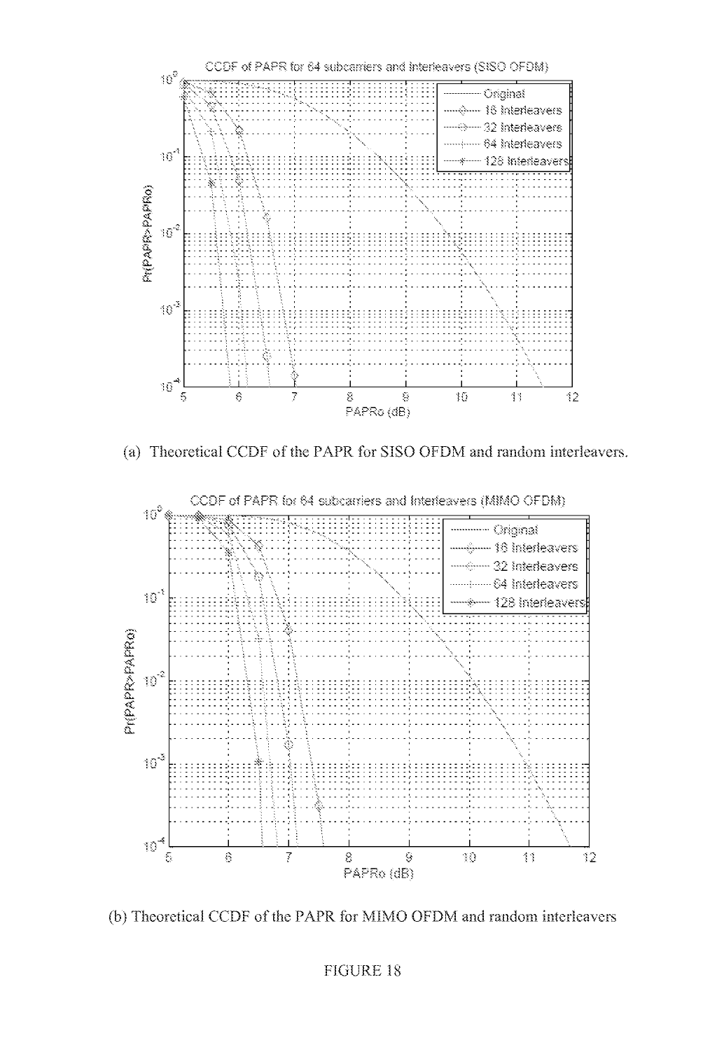

In FIG. 18, the theoretical CCDF of the PAPR of both SISO and 2×2 MIMO OFDM are plotted. These plots show that the relative improvement of the PAPR performance is quite similar in single links and multiple link scenarios using random interleavers.

In the next section, the achievable performance with the proposed scheme of the invention is analyzed. Theoretical expressions are compared against simulated values to verify the accuracy of these approximations.

Simulated CCDF of Proposed Scheme

The proposed scheme of the invention is a system that essentially interleaves OFDM frames. The main two differences with respect to a random bit interleaver solution are: first, bits are not uniformly distributed across sub-carriers and, therefore, different number of bits will be assigned to different resources. Second, and most relevant, is the fact that the permuted sequences are found by rotating symbols and not bits. This means that when high order modulation orders are predominant, rotations of these symbols will correspond to rotations of “groups” of bits. Therefore, an exact match with theoretical expressions provided in the previous section is not expected given that some correlation with the initial sequence of bits may exist.

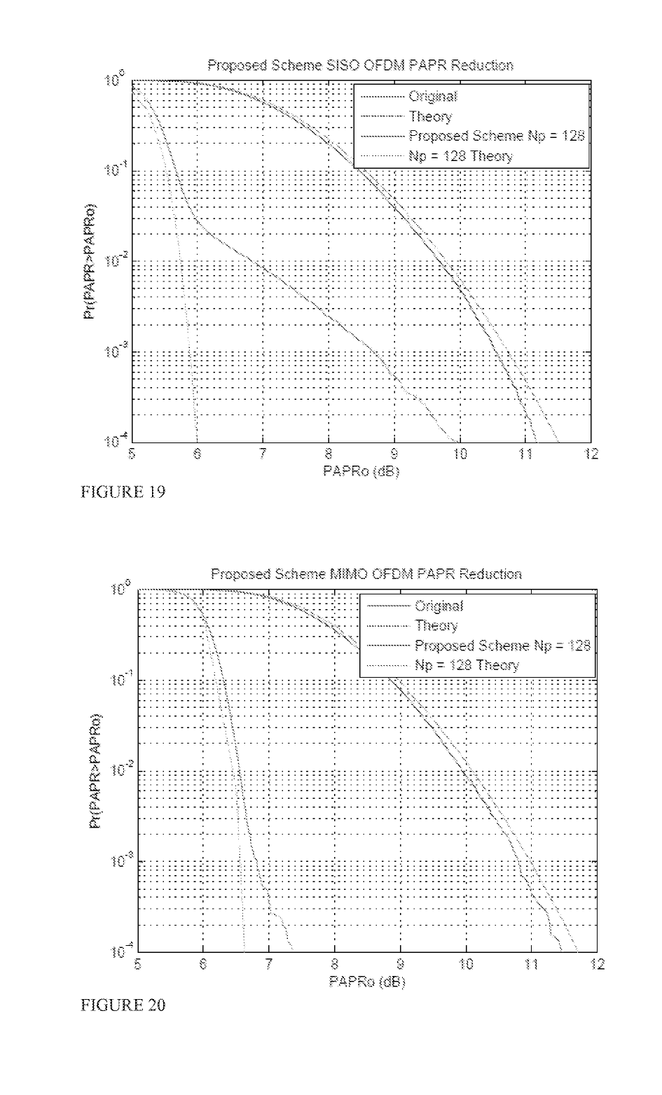

In FIG. 19, the improvement achieved for the SISO case is shown. It is not included herein, but an OFDM system at different SNR values was simulated and different SNRs resulted in different allocations. However, different allocations did not result in different CCDFs of the PAPR so a particular set of simulated values was selected. The theoretical CCDF of the PAPR of SISO OFDM is plotted jointly with the theoretical CCDF of interleaved OFDM. Additionally, a system implementing the proposed solution with N_{P}=128 is also graphed.

It is evident from FIG. 19 that the agreement between simulation and the theory is not exact. In fact, the theory outperforms the proposed scheme. These results very closely resemble the simulations shown by A. D. S. Jayalath and C. Tellambura in “Use of data permutation to reduce the peak-to-average power ratio of an OFDM signal,” In Wireless Communications and Mobile Computing, Volume 2, pages 187, 203, 2002, where the same behavior is observed when symbol and bit rotation are compared. After the 6 dB threshold, the probability of the PAPR is not as small as expected. Also, it is important to notice that this separation from the theory happens at very small probabilities and it does not represent a significant drawback in the proposed scheme of the invention. Further, the proposed scheme of the invention still outperforms traditional schemes along the entire range of simulated thresholds.

As shown in FIG. 20, for the 2×2 MIMO OFDM simulations, a similar trend as in the single link scenario is observed. The original system perfectly matched simulation, but the interleaved system lacked exact agreement. However, the theoretical expression seems to better approximate the simulated CCDF of the PAPR compared to the SISO scenario. A reason for this can be explained due to the fact that in MIMO there are more degrees of freedom, as the number of sub-carriers is twice that of SISO and more diversity when permuting the symbols is achieved. However, at very small probabilities, the same effect can be observed.

### Hardware Implementation

To make a more elaborate analysis of the proposed algorithms of the invention and show the benefit of symbol rotation, the SS-CSRI and SS-CARI were implemented in a real test bed scenario. Wireless Access Research Platform (WARP) software defined radios developed by Rice University were used within the WARPLab framework (http://warp.rice.edu) to convey the information between nodes. On each node, a software OFDM SISO and MIMO transceiver (similar to the ones specified by the 802.11a/b/g standards) were used to transmit and receive OFDM data packets. All the signal processing is done in Matlab and the nodes are used as buffers. In the implementation, all extra information needed to synchronize the nodes, perform channel estimation and account for frequency offsets was considered.

WARPLab

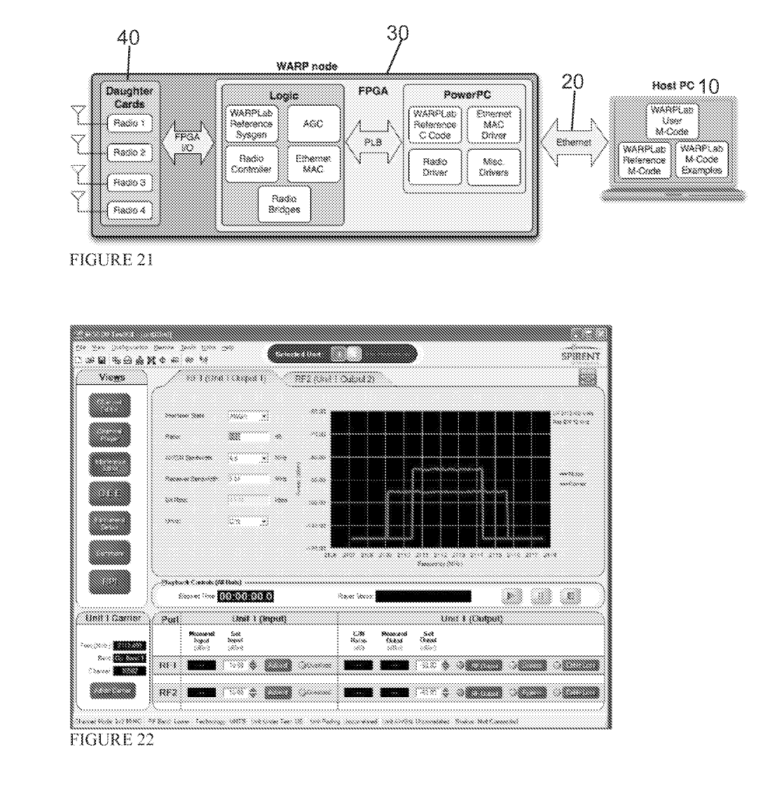

WARPLab is the framework developed at Rice University that combines Matlab and the WARP software defined radios. This framework allows for easy prototyping of different physical layers and the direct creation and transmission of signals through the WARP nodes (see FIG. 21).

The steps to transmit information within this framework are summarized next. First, sequences of data to be transmitted (from any physical layer design) are generated in a host PC 10 using Matlab. Then, the samples are downloaded to buffers within the boards via Ethernet connections 20. After this, the transmit and receive nodes 30 are triggered using the same host PC 10 to start the data transmission. The transmit board sends the stream of data through a daughter card 40 at the receiver end, and the card 40 receives the data in a similar way. In MIMO communication, more than two daughter cards send the samples. As soon as the trigger is received, the data at the receiver node 30 is sent to the host PC 10 in real time. At the end, all the received information can be stored for offline processing or it can be processed in real time. For more detailed information regarding the board specifications, see http://warp.rice.edu.

Channel Emulator

To create a controlled scenario in measurements, a Spirent Channel Emulator (SR-5500M) was used. This emulator allows to test different wireless environments from several known standards in addition to customized conditions in which measurements are taken. As an example, for a multipath scenario, the number of rays, loss, fading and delay spread are some of the parameters that can be set. It is also possible to “playback” user defined channels that incorporate antenna radiation patterns that can be taken into account by modifying channel correlation properties. The available ports in the device allow for testing of 2×2 MIMO antenna systems.

Another useful capability of this tool is that allows for the addition of interference as Additive White Gaussian Noise (AWGN) into the channels independently. It provides an interface where the user can easily set the receiver bandwidth and the amount of relative noise to add (see FIG. 22). This allows us to run sets of measurements at different SNRs without physically repositioning the nodes, which is extremely useful in testing rate adaptive schemes and bit error rate performance where different SNRs are desired.

Hardware Set Up

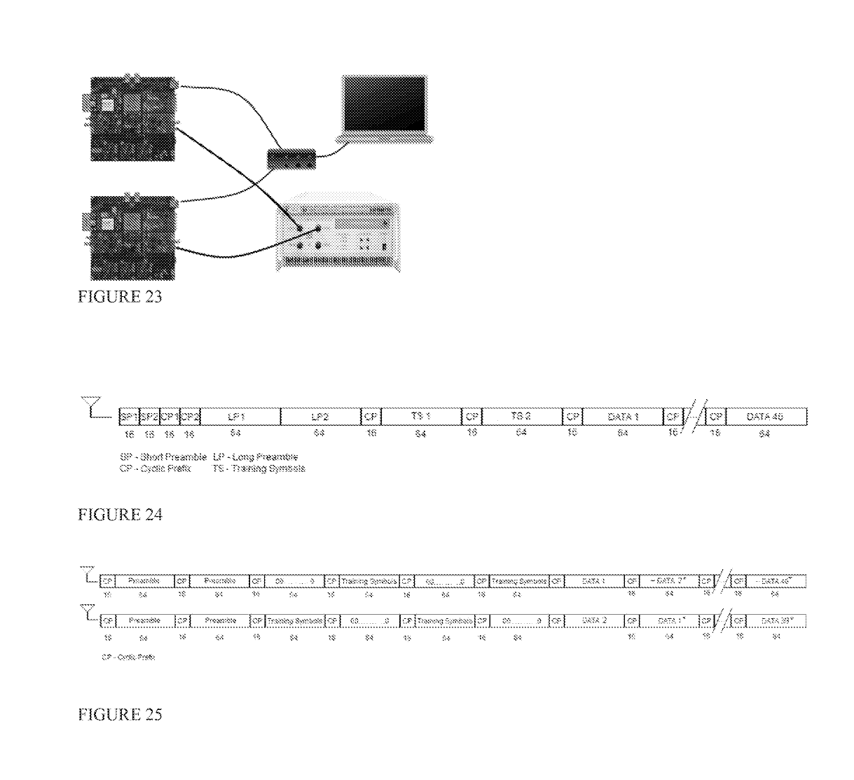

To make a fair comparison between algorithms while keeping the essence of real measurements, the wireless channel emulator was used jointly with the WARP boards and WARPLab framework. The nodes were connected to the emulator using two “−3 dB loss jumpers” for the single link measurements and four jumpers in the multiple link setup as shown in FIG. 23. The carrier frequency on both devices was set to 2.424 GHz and depending on the number of links to test, two or four ports of the emulator were enabled.

To achieve different SNR values, the emulator interference AWGN functionality was enabled so that each set of transmissions was performed at a desired SNR. In order to manipulate the emulator, another host pc with the necessary software was used.

Transceiver Description

The general transceiver structure of the implemented system is the same as the system shown in FIG. 4. However, a more detailed description of how the frames are structured is presented next.

SISO OFDM Transceiver

For the SISO framework, short preamble symbols are first introduced into the frame for coarse frame detection and carrier frequency offset (CFO) estimation. Next, two long preamble symbols are introduced for fine timing and fine CFO estimation. Finally, to estimate the channel over the data sub-carriers, two training symbols were appended as well. After all header information is introduced, the information symbols follow. To reduce the inter symbolic interference, a cyclic prefix is inserted between symbols when the frames have already been transformed to the time domain. FIG. 24 shows the diagram of an OFDM frame with 40 OFDM symbols and 64 sub-carriers.

MIMO OFDM Transceiver

For MIMO OFDM, the frames were built differently compared to SISO. In this implementation, preamble sequences are inserted to both streams and are used to determine the beginning of the frame at each of the receiver antennas. Then, sequences of training symbols combined with sequences of zeros follow. These symbols are placed in this manner (see FIG. 25) so that when the training sequence is being sent through one of the antennas, the other is sending zeros, and vice versa. Under the assumption that the channel does not change within the OFDM frame transmission, this logic allows for easy estimation of the MIMO channel entries h_{i,j}, where h_{i,j} corresponds to the channel between transmitter j and receiver i. After all header information, the actual data is inserted to each of the streams following the Alamouti physical layer: if X₁ and X₂ OFDM symbols are to be sent through antennas 1 and 2 respectively, −X*₂ and X*₁ are sent through antennas 1 and 2 at the next instant of time. After all the symbols are transformed into the time domain, the cyclic prefix is inserted between symbols to avoid inter symbolic interference.

On both SISO and MIMO OFDM implementations, pseudo random sequences of known symbols were embedded in four sub-carriers. These symbols, commonly known as “pilots”, were used for carrier frequency offset tracking.

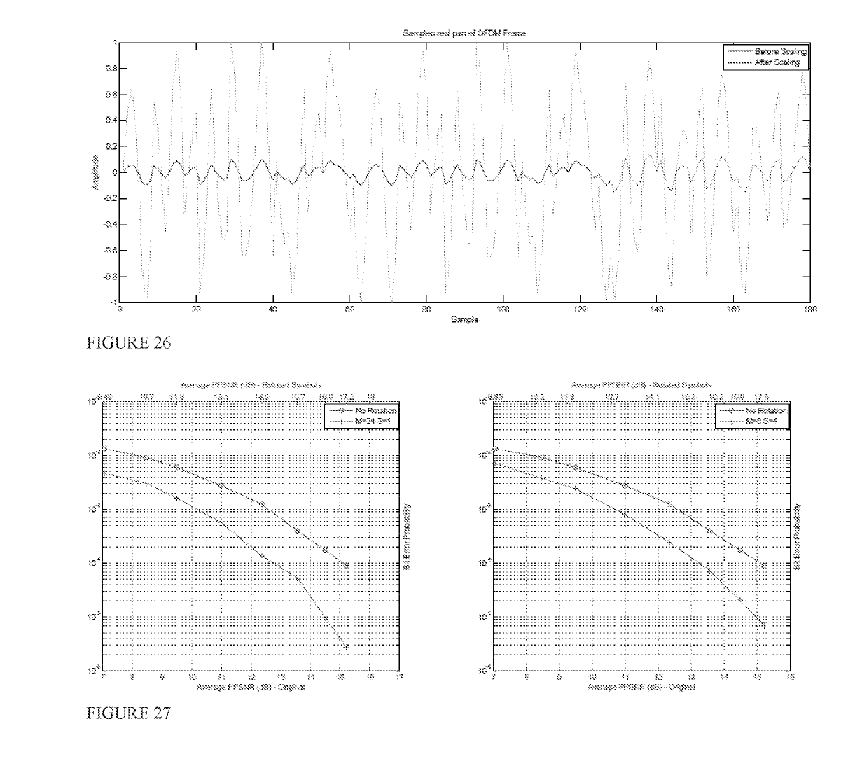

The real and imaginary components of the time domain signal vector of the OFDM frame are scaled prior to transmission. Data scaling is performed before sending samples to the A/D converter due to the requirement that the signal must vary within [−1; 1] to use the full range of the converter. To achieve this, different scales for different portions of the frame are determined and applied to the frames. Finally, the real and imaginary components of the sampled signal happen to be within this range as shown in FIG. 26.

The scaling factor (SF) for the data portion of the OFDM frame determined at each transmission is defined as:

$$SF = \frac{1}{max [ \vert Re ( {x}_{k} ) \vert , \vert Im ( {x}_{k} ) \vert ]} \qquad ( 34 )$$

where |Re(xₖ)| and |Im(xₖ)| correspond to the absolute value of the real and imaginary components of the sampled transmit OFDM signal x(t) respectively.

After all processing, the data vector is upsampled by a factor of 4 in order to occupy the desired bandwidth of 10 Mhz. This is because the WARP nodes sampling rate is fixed at 40 MHz. At the receiver side, the data vector is first downsampled and symbols are obtained by means of zero forcing equalization in the SISO system. Channel estimates found with training sequences are inverted to perform this task. For the MIMO framework, the process is almost the same except that maximum likelihood detection is implemented following S. M. Alamouti, “A simple transmit diversity technique for wireless communications,” Selected Areas in Communications, IEEE Journal on, 16(8):1451-1458, October 1998.

Performance Metric

The chosen metric to evaluate the performance of the mentioned schemes and proposed solution is the inverse of the error vector magnitude or also known as post processing SNR (PPSNR). This quantity is a measure of symbol spreading at the receiver side—the complex symbols sent within an OFDM frame are affected by the channel between transmitter and receiver, therefore the module and phase differ from the symbols sent originally. The PPSNR is defined as the inverse of the mean squared distance of sent and received symbols:

$$PPSNR = \frac{1}{E [ {\vert r ( k ) - s ( k ) \vert}^{2} ]} \qquad ( 35 )$$

where s(k) and r(k) correspond to the transmitted and received symbols respectively. This metric is very good in terms of evaluating performance as it accounts for every element that degrades the transmission of information. However, it does not provide the information regarding elements of the transmission chain responsible for degrading the system performance. External components, independent of the communication system such as interferers, may degrade the PPSNR and will not provide an accurate picture of what is affecting the transmission.

In the next section, the performance of the proposed schemes of the invention using this quantity and the obtained improvement is compared to a system that does not use the algorithm. The improvement will be a measure of the proposed algorithm's effectiveness.

### Results Analysis

As explained above, the performance of the SS-CSRI, SS-CARI and the proposed solution has been evaluated at the transmitter in terms of PAPR reduction. A notion of achievable PAPR reduction was shown by means of CCDF plots for all the schemes. However, in this section we introduce another metric to address the overall performance improvement by gathering information from simulations as well as real measurements. The scope is going to be extended to the receiver where correctly received bits (or throughput), bit error rates and PPSNR are analyzed.

The SS-CSRI and SS-CARI schemes were implemented in the WARP testbed to prove the benefits of PAPR reduction by rotations in a real environment. In all sets of measurements, random information bits were first sent without any modification, and later, the same random bits applying either of the algorithms were sent. To make a fair comparison, the transmitter gain at every transmission in the WARP nodes was not modified and the emulator noise power was varied exactly in the same way. In this framework, the peak power remained constant and the noise power level was varied accordingly. Therefore, the only difference between experiments will be how the information bits are processed, as no hardware modification or adjustments were made.

However, evaluating the schemes that perform bit allocation was a challenge since, in bit-loading schemes, the number of bits per transmission might change and, therefore, creating the same random bits does not contribute to a fairer comparison. Synchronization between the emulator and the WARP nodes is not trivial. Therefore, to keep the same allocation between experiments, computer simulations are the best way to compare these schemes. Unfortunately, running user defined samples in the emulator does not allow the user to enable the AWGN functionality and hence, made the task of varying the PPSNR infeasible.

SS-CSRI Results

First, the bit error rate of the unmodified system versus the system applying the algorithm is addressed. In FIG. 27, the BER curves of the system that selects the sequences with minimum PAPR are also plotted along the same set of axes to see the improvement. On the left graph, the original system is compared to the SS-CSRI with M=24 and S=1. On the right, the same comparison is done but with M=6 and S=4. At a first glance, the BER of each set of points has improved at every PPSNR value. This does not mean that the BER for this modulation scheme changed, but an improvement in the average PPSNR places the new BER curve underneath the unmodified system. The top x-axes indicate the actual value of the PPSNR of the system that rotates the symbols. It can be seen that at every point there is an improvement in the PP SNR.

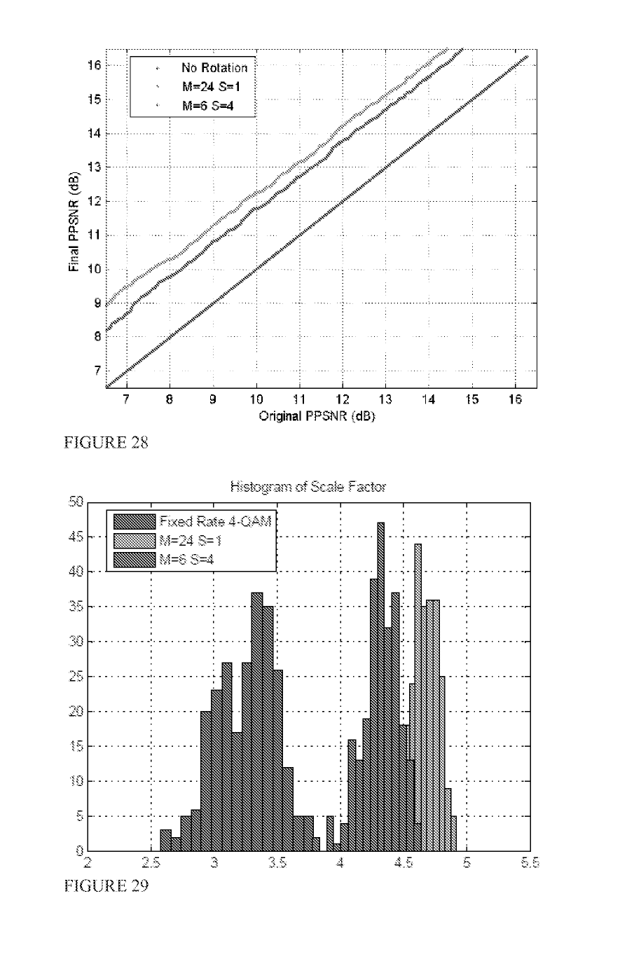

A scatter plot of the PPSNR in FIG. 28 clearly shows how PAPR reduction using symbol rotation leads to an improved PPSNR. In FIG. 28, the original average PPSNR for each set of points is plotted versus the modified system average PPSNR. It is important to stress that the PPSNR values were sorted in order to clearly see the benefit at different levels. This quantity is very sensitive to channel variations and, due to not having an extensive set of measured samples, does not approximate the improvement accurately.

A constant improvement of approximately 2 dB is observed when 96 rotations are performed (M=24 and S=1). Less rotations still show an improvement of 1.5 dB over the original system. However, the main question that arises is why there is an improvement if only the PAPR is being reduced, the average OFDM symbol power is not modified and, there are no amplifier non-linear distortions incorporated. The answer to this question is the signal scaling before the D/A conversion. Under the assumption of uncorrelated bits, the average transmit power of the OFDM symbols will remain unchanged for any number of rotations. However, the peak to average properties do not remain invariant. For each set of bits to be transmitted, the histograms of the scaling factor (SF), defined above, were computed and plotted as shown in FIG. 29

As shown in Table 10, the distributions of the scale factor allow the characterization of the average improvement on the transmit power when different rotations are performed. The mean value of the scale value is increased from 3.25 to 4.66 on average. In terms of average transmit power, this improvement corresponds to a 3.1 dB increase.

TABLE 10
Mean and variance of the scaling factor when the
SS-CSRI scheme is applied.

| SF | Original | M = 6; S = 4 | M = 24; S = 1 |
|---|---|---|---|
| Mean | 3.25 | 4.31 | 4.66 |
| Variance | 0.057 | 0.022 | 0.012 |

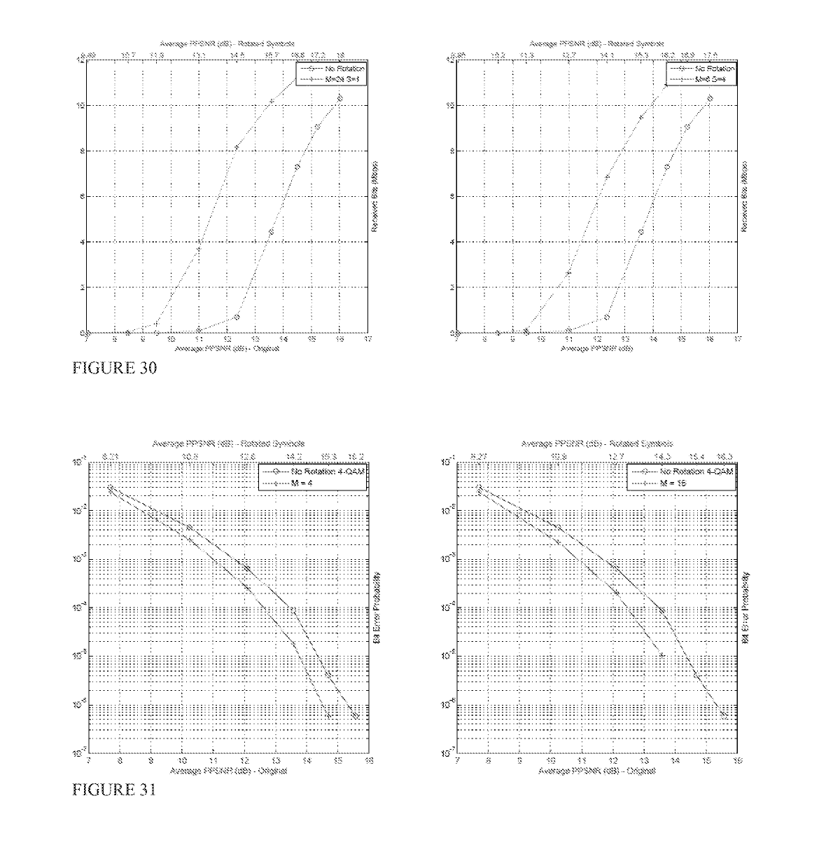

Additionally, an important reduction in the variance of this parameter is observed. This happens because the OFDM signal with small PAPR corresponds to an x(t) sequence that statistically has small peak occurrence probability and the same average transmit power. Therefore, the signal variations are reduced. In terms of system throughput, an improvement is evident. Given the fact that there is no bit error rate constraint, the modified system throughput is always superior to the unmodified system at every PPSNR value as shown in FIG. 30.

One skilled in the art will notice that improvement in the amount of received bits is relative in the sense that the PPSNR at the receiver is improved and constitutes the main reason why the algorithm outperforms. For the fixed rate system measurements, the throughput starts converging to 12 Mbps at around 17 dB.

SS-CARI Results

In the same light as in the single link analysis, this section characterizes the effect of the SSCARI scheme after considering further metrics. Bit error rate, PPSNR variations and received bit improvements are described. In the case of the system BER, the SS-CARI scheme with parameter M=4 and also M=16 outperforms the unmodified system (see FIG. 31). Again, the improvement in transmit power at each of the antennas leads to an improved PPSNR. As a result, the bit error probability for all the sets of transmitted bits is reduced.

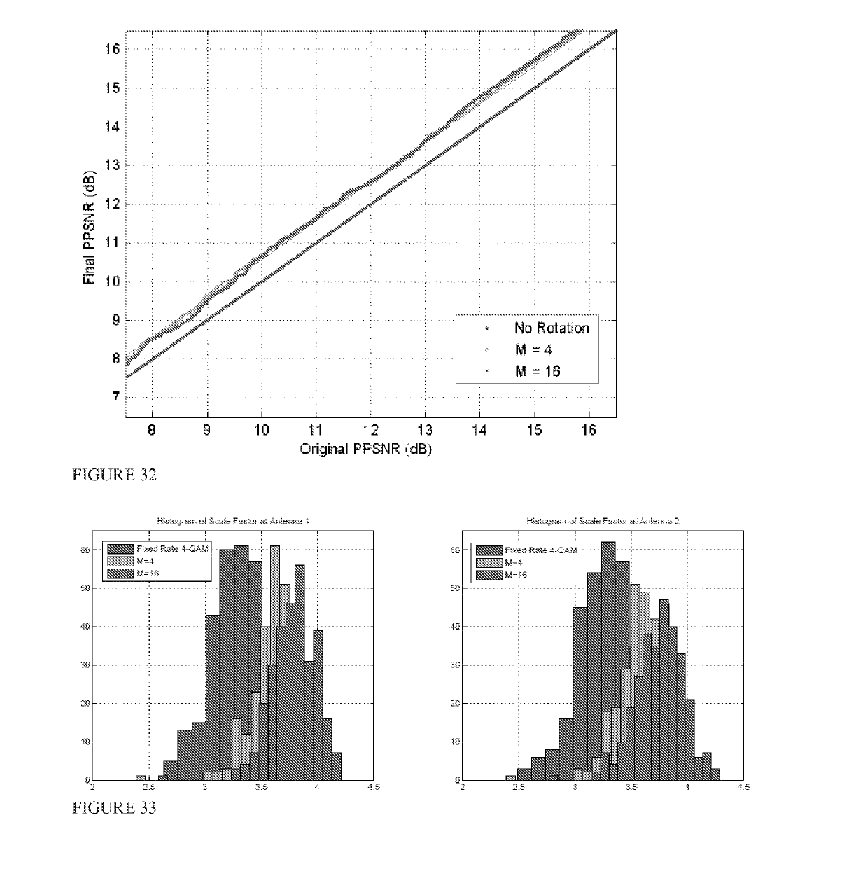

A scatter plot of the PPSNR in FIG. 32 after sorting the data shows how the SS-CARI scheme succeeds in improving the system performance. A closer improvement between rotations with M=4 and M=16 is observed, but the overall improvement is not much compared to the SS-CSRI scenario. The reason for this is that the pair with minimum maximum PAPR is not always the best for each of the antennas but is rather optimized for the pair. Therefore, finding the best minimum maximum PAPR pair might contribute to higher PAPR in either of the antennas (compared to the original sequence). As shown in FIG. 33, the overall effect of the algorithm is always positive; an improvement of almost 1 dB is observed at every PPSNR for the number of rotations presented. It is also interesting to see that in this scenario, increased rotations do not yield a significant relative improvement.

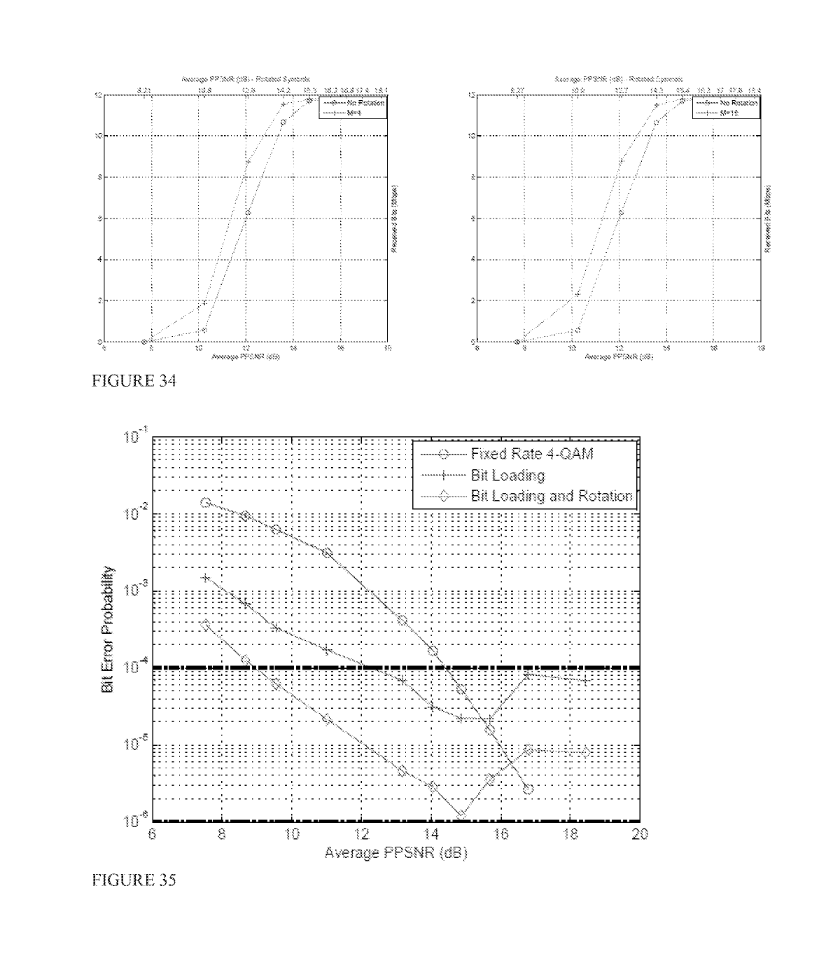

From the scaling factor perspective, the improvement in the average transmit power can be estimated as described before (see FIG. 34). In comparison to the SS-CSRI scheme, the distributions are relatively closer to each other and their respective variance is not significantly modified. This improved scales result in a PPSNR improvement of smaller magnitude. In Table 11, the improvement of the PAPR reduction in the scale factor is shown. From these values, the estimated improvement in total average transmit power is approximately 0.93 dB, which matches the improvement achieved in PPSNR.

TABLE 11
Mean and variance of the scaling factor
when the SS-CARI scheme is applied.

| | Antenna 1 | | | Antenna 2 | | |
|---|---|---|---|---|---|---|
| SF | Original | M = 4 | M = 16 | Original | M = 4 | M = 16 |
| Mean | 3.27 | 3.64 | 3.79 | 3.25 | 3.61 | 3.75 |
| Variance | 0.068 | 0.042 | 0.040 | 0.068 | 0.047 | 0.045 |

As shown in FIG. 34, the system throughput also showed an improvement at all measured PPSNR values. Similar to the single link case, the improvement on this quantity remains constant as there is no bit error rate constraint. The throughput converges also to 12 Mbps as in the single link scenario. Intuitively, we would expect that a MIMO system would achieve a higher throughput, but the OFDM symbols were sent using the Alamouti physical layer which aims to provide a more robust transmission and not improved throughput.

### Results

It was assumed above that information collected from real measurements showed how PAPR reduction leads to an improvement in various aspects of the communication system. This motivates the implementation of the proposed scheme of the invention with the interest of analyzing the effect of transmit power increment in rate adaptive algorithms. As mentioned above, Matlab simulations were used to characterize the proposed scheme of the invention.

To evaluate the performance and have a precise baseline to compare schemes, the same random number seeds, and same amount of rotations N_{P} for SISO and MIMO OFDM systems were used. The main difference in this analysis relies in the symbol allocation to meet a desired BER constraint; at every transmission the bits were not uniformly distributed. However, computer simulations allowed us to have the exact same allocations with and without rotation such that the same symbols were sent between trials.

In all experiments, lookup tables for bit allocation consisted of modulation orders and PPSNR values to achieve error rate probabilities between the 10⁻⁴ and 10⁻⁶ range. The allocation process was performed as described above and the simulations environment was very close to measurements. To avoid confusion when presenting these results, all the quantities are plotted versus PPSNR estimates from training sequences. These estimates are not affected by peak reduction and symbol rotation because the training symbols are not modified when being transmitted. Additionally, sequences used to train for the channel were not considered for calculations such as throughput and relative improvements.

SISO OFDM Loading and Rotation

The first quantity to analyze is the bit error rate probability of the proposed system of the invention (see FIG. 35). For high PPSNR values, the BER probability remains within the 10⁻⁴ and 10⁻⁶ interval (lookup table bounds). The breakpoint of this happens around 14 dB and the BER of the proposed scheme outperforms a system that only allocate bits. This is also due to an improvement in the average transmit power of the rotated symbols. The PPSNR of the modified sequences could have been shown, but it is important to emphasize that the allocation is performed with the PPSNR values of training sequence. Therefore, the benefits of PAPR reduction with symbol rotation will be plotted along the values of the unmodified system.

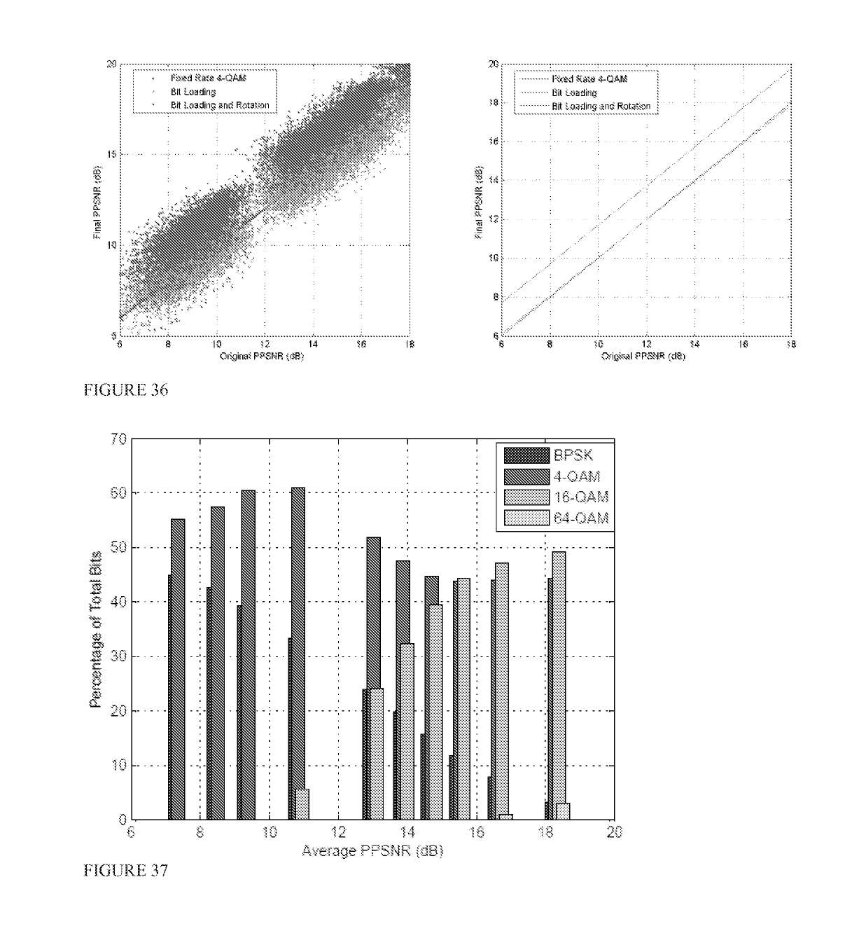

The statistics of the PPSNR from training frames will remain unchanged if compared to the PPSNR of the unmodified system. However, the PPSNR of frames with non-uniform allocations and rotated symbols is modified. For the allocation process, the emphasis is on the PPSNR in training frames and the improvement achieved can also be characterized using a scatter plot of the PPSNR as shown in FIG. 36. In FIG. 36, sorting was not necessary as simulations allowed to run extensive sets of measurements at very specific PPSNR values. The PPSNR of the rotated symbols is compared to the PPSNR of a bit-loading scheme that does not rotate them. On the left, the raw data is shown in a scatter plot; on the right, a first order polynomial fitting to the three sets of data using the Matlab function “polyfit( )” is plotted.

Two important effects can be observed. First, rate adaptation does not modify the statistics of the PPSNR which can be concluded when considering that the lines for fixed rate and bit-loading are almost identical. Second, bit allocation and symbol rotation with random interleavers lead to improved PPSNR. The total improvement is on average 1.5 dB compared to the original system. For the current implementation, this does not mean that more bits will be allocated but rather that the assigned bits will be sent in a more reliable way. This happens because the allocation process is done with training sequences that are not sent with reduced PAPR.

Percentages of symbol allocation at different PPSNRs are shown in FIG. 37. 4-QAM is the dominant scheme around 10 dB and as the PPSNR increases, higher order symbols start predominating (16-QAM). However, simulations showed that heterogeneous bit distributions do not affect the improvement in PPSNR. In FIG. 36, the improvement at every PPSNR is constant and fixed, depending only on the number of permutations. In terms of throughput, the proposed scheme of the invention is compared to a system that only allocates symbols without rotations. To test the allocation scheme, fixed 4-QAM rate transmissions are compared against a system that allocates bits using look up tables as shown in FIG. 38.

Clearly, the system that allocates bits outperforms the fixed rate scheme, giving rise to the framework that will be underneath the proposed solution. After 16 dB, there is a breakpoint where the improvement is no longer linear and the systems starts tracking the BER constraint. It is clear to see that the proposed scheme outperforms the traditional at all PPSNR values. The reason is that the symbols are being sent with higher transmit power and therefore, a reduced number of frames are detected in error. Also, the order of magnitude in BER determines how much improvement in throughput is expected; the smaller the target BER is, the smaller the improvement in throughput. For high PPSNR, high modulation orders dominate and a high number of bits are sent. If the BER is too small, a difference of 1 or 2 frames received correctly out of 10⁵ will not make a significant improvement. This is the reason why in this implementation, improved reliability but not improved throughput is expected. On the other hand, as soon as the BER increases, higher BERs have a greater impact on throughput.

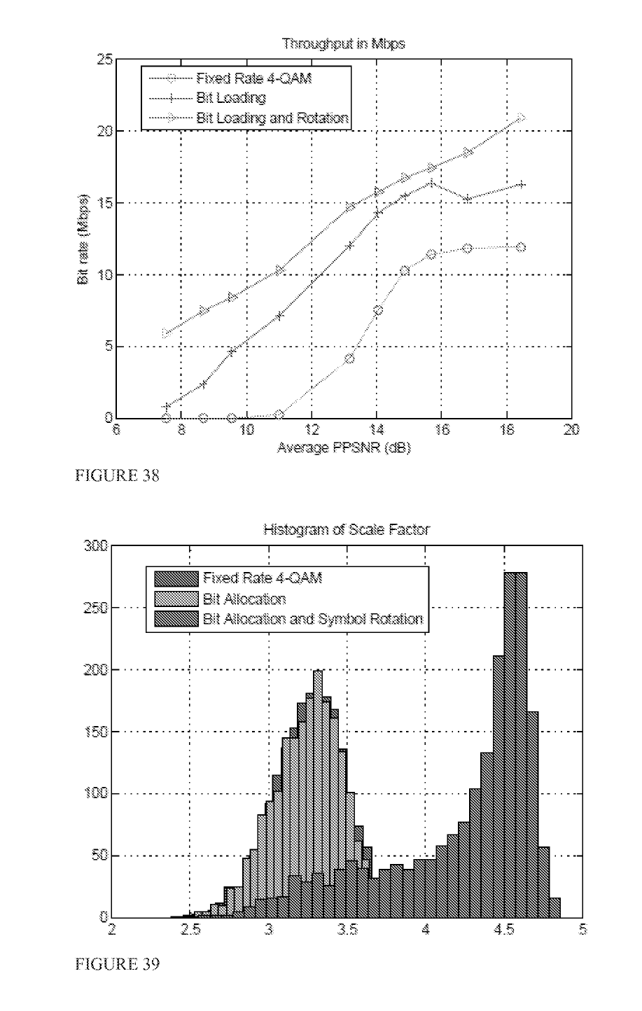

The distributions of the scaling factors for each of these schemes are analyzed with respect to FIG. 39. These histograms show that bit allocation does not change the distribution of the scale factor. However, when the symbols are rotated, the statistics of the scale change. The mean value improves, but the variance increases to the extent that the distribution tails become noticeable. This result follows what was observed with the PAPR distribution. We have seen that symbol rotation does not lead to the same diversity as bit rotation and that using random interleavers instead of using an ordered way to randomize the data (SS-CSRI) does not lead to the same improvement. Even though the variance of the scale distribution is greater, the histogram shows that the occurrence of these smaller values is not significant compared to the original system and can improve the system performance.

MIMO OFDM Loading and Rotation

In this section the performance of the proposed scheme for MIMO OFDM is addressed. For these simulations, the same amount of symbol permutations as in the single link scenario were performed to frames that conveyed the same amount of data bits. Three-tap 2×2 frequency selective channels were generated to run the simulations of the MIMO OFDM system.

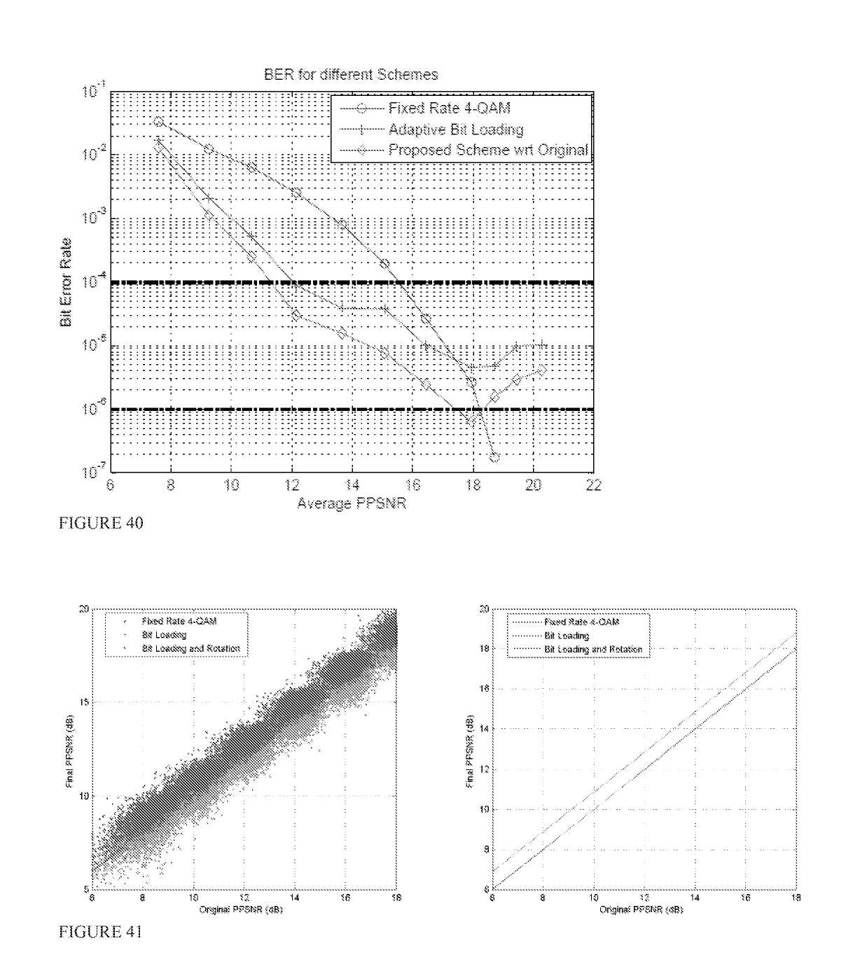

First, the bit error rate of the scheme is analyzed with respect to FIG. 40. The system is able to keep the BER bounded to the specified limits in the same way as in the single link scheme. At 18 dB, there is a breakpoint where the BER starts varying within the interval 10⁻⁴ and 10⁻⁶. The proposed scheme of the invention is able to outperform the system that only allocates bits over the two streams. Again, an improvement in the average transmit power at the antennas is responsible for such difference. In comparison to the single link allocation, the simulated channel allowed the system to converge faster.

The scatter plots of the PPSNR in FIG. 41 show the improvement in the PPSNR of frames with rotated symbols. In the same light as in the single link scenario, there is no need to sort the data given the significant amount of simulated values. The allocation in MIMO does not change the statistics of the PPSNR as well. The right plot of this figure provides lines fitted to the data to show this effect. Also, the rotation of symbols leads to an improvement of almost 1 dB on average, which is slightly smaller compared to the single link case.

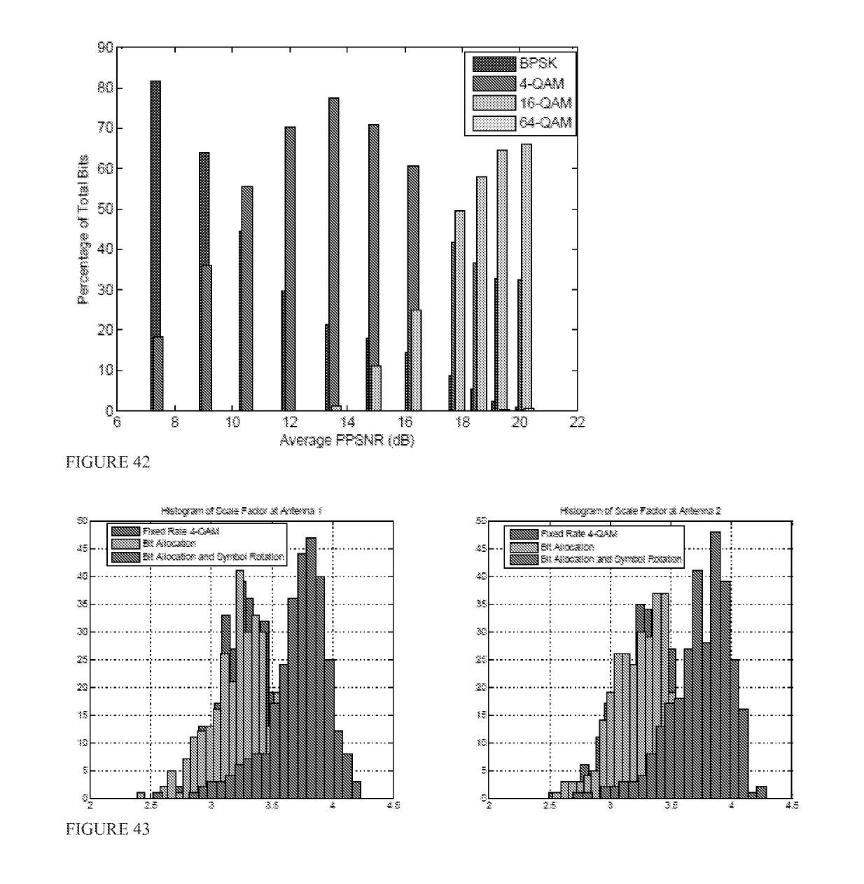

The symbol allocation for the MIMO measurements is shown in FIG. 42. It is observed that at small PPSNR values, BPSK symbols are predominant in terms of allocation percentage. At PPSNR values around 20 dB, most allocated symbols are 16-QAM and a small percentage of 64-QAM are also allocated. As has already been stated, this heterogeneous symbol distribution at different PPSNR values does not modify the statistics of the PPSNR nor scaling factor in the MIMO scenario.

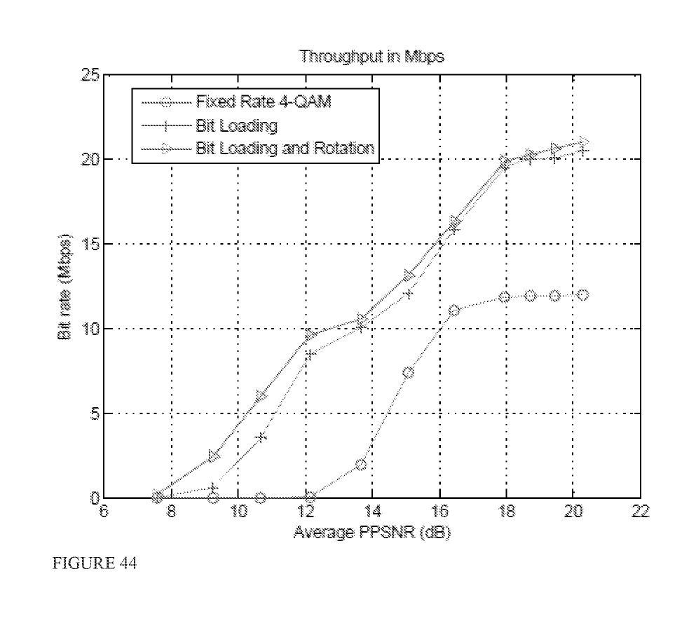

The distributions of the scale factor for each of the antennas are plotted in FIG. 43. Making the same number of rotations as in the single link case, shows how PAPR minimization in MIMO OFDM is not as efficient as in SISO OFDM. The improvement in the mean scale value is not as pronounced as in the single link case. However, the histogram of rotated symbols does not present a prominent tail as observed in SISO. This improvement resembles the simulations of bit rotations for MIMO OFDM links even though symbols are being rotated. Because of how the algorithm works, gathering and rotating the symbols of both streams and after rotating these, the diversity is more significant compared to the single link, where long tails were observed. Finally, the throughput of the proposed scheme for MIMO OFDM is analyzed with respect to FIG. 44 and compared against a rate adaptive scheme that do not rotate symbols. Similar to SISO OFDM, the allocation process is verified by comparing the system to a fixed rate (4-QAM) transmission.

Clearly, the adaptive bit-loading scheme outperforms the fixed rate transmission at every PPSNR. The proposed scheme of the invention outperforms the adaptive scheme at every SNR. The improvement in received bits remains relatively constant and around 19 dB, the gap becomes even greater. The reason for this is the BER constraint order of magnitude, where a better number of frames decoded correctly is appreciable.

### CONCLUSION

Two PAPR reduction schemes were simulated and implemented in hardware. Simulations of the PAPR CCDF, verified the potential of these schemes to reduce the PAPR of SISO and MIMO OFDM systems. Moreover, both schemes were implemented and evaluated using software defined radios as transceivers similar to those specified in 802.11 standards. It was seen that in implementations where the transmit power is constraint to the signal peaks, PAPR mitigation leads to increased average transmit power resulting in reduced BER and higher throughput when there are no BER constraints.

Second, a new scheme has been provided herein that combines the benefits of adaptive bit-loading and PAPR reduction for both SISO and MIMO OFDM systems. The schemes were implemented and simulated in Matlab. Results showed the potential of PAPR mitigation comparable to the SS-CSRI and SS-CARI algorithms proposed in SISO and MIMO OFDM systems. The fact that the proposed scheme of the invention is based on these two algorithms, similar performance was expected. Simulations showed that in rate adaptive schemes where a target BER is present, the PAPR reduction also lead also to reduced bits error rates and therefore, the allocated bits are sent in a more reliable way. This makes the entire system more robust against channel impairments. In terms of the implementation, the data scaling procedure may generate discredit as the entire frame needs to be generated to determine this value resulting in delays. However, in real implementations there are also delays while generating the system frames—a clear example is the cyclic prefix insertion that is needed to “repeat” the last symbols of the frame to reduce the inter symbolic interference.

In terms of side information, the proposed scheme of the invention uses a fixed number of side bits that depend only on the total amount of permutations per transmission N_{P}. On the other hand, the amount of side information in SS-CSRI and SS-CARI depends on how many divisions are performed on the data.

It has been shown herein that through distributions functions that PAPR is proportional to the number of sub-carriers. This motivates the need to keep improving PAPR reduction techniques and evaluate them in communication systems where the number of data sub-carriers is much greater than the number analyzed herein. It is expected that in these frameworks, the benefit of PAPR reduction will have a greater impact as statistically the probability of high PAPR is more significant. For example, practical applications of the method described herein may be used in ultra-wideband (UWB) systems or current wireless standards that employ 256 or more carriers.

Those skilled in the art may also characterize the throughput improvement when accounting for the transmit power increase. In other words, by rotating the symbols, we are increasing the transmit power and consequently increasing the SNR at the receiver. If we could account for this improvement before the allocation, it would be possible to allocate more bits for the same target error constraint resulting in significant throughput improvement. To achieve this task, a statistical characterization of the PPSNR distributions would allow the creation of confidence intervals to account for the PPSNR improvement when a fixed amount of rotations is performed.

In addition, any scheme that requires the transmission of overhead information to recover the symbols at the receiver will always aim to reduce this overhead as much as possible. Therefore, the need to reduce the amount of side information is present and can always be improved. It is important to stress that rate adaptation and PAPR mitigation through successive rotations are two components that perfectly complement each other and give rise to a new framework that can allocate bits in a more reliable way or that can achieve higher throughput when the transmission power improvement is accounted for.

Those skilled in the art will appreciate that the algorithms described herein are typically implemented in software on one or more processors that are in operative communication with a memory component. The processor may include a standardized processor, a specialized processor, a microprocessor, or the like. The processor may execute instructions including, for example, instructions for modulating symbols onto individual carriers at carrier frequencies independently and implementing a peak-to-average-power ratio reduction algorithm to search the transmit carrier frequencies successively to find a transmit sequence with a reduced peak to average power ratio. The memory component that may store the instructions that may be executed by the processor. The memory component may include a tangible computer readable storage medium in the form of volatile and/or nonvolatile memory such as random access memory (RAM), read only memory (ROM, cache, flash memory, a hard disk, or any other suitable storage component. In one embodiment, the memory component may be a separate component in communication with the processor, while according to another embodiment, the memory component may be integrated into the processor.

Those skilled in the art will also appreciate that the invention may be applied to other applications and may be modified without departing from the scope of the invention. Accordingly, the scope of the invention is not intended to be limited to the exemplary embodiments described above, but only by the appended claims.

What is claimed:

1. A method of transmitting data in a multi-carrier transmission system, comprising:
allocating transmission symbols to subcarrier frequencies;
scrambling the transmit symbols after allocation simultaneously and successively;
finding a transmit sequence with a reduced peak to average power ratio; and
transmitting the symbols of the transmit sequence with the reduced peak to average power ratio.

2. A method as in claim 1, further comprising interleaving the symbols for transmission in groups of subcarrier frequencies to modify the amount of symbol permutations.

3. A method as in claim 2, wherein the different groups of subcarrier frequencies carry symbols from the same symbol alphabet.

4. A method as in claim 1, wherein said multi-carrier transmission system comprises a single input single output transmission system or a multiple input multiple output transmission system.

5. A method as in claim 4, wherein the symbols are transmitted using orthogonal frequency division multiplexing.

6. The method as in claim 1, wherein the searching step is repeated successively a predetermined number of times to find a transmit sequence that results in a minimum peak to average power ratio.

7. The method as in claim 1, wherein the transmit sequence of scrambled symbols assigned to subcarriers are selected to provide an increased transmit power over the transmit subcarrier frequencies.

8. The method as in claim 1, wherein the step of allocating transmit subcarrier frequencies for transmission of symbols comprises independently modulating individual carriers at said subcarrier frequencies.

9. A multi-carrier data transmission system, comprising:
a processor that implements an adaptive bit loading algorithm to modulate symbols onto individual carriers at carrier frequencies independently;
a processor that implements a peak-to-average-power ratio reduction algorithm to search the transmit carrier frequencies successively to find a transmit sequence with a reduced peak to average power ratio; and
a transmitter that transmits the symbols on the transmit sequence of subcarriers with the reduced peak to average power ratio so as to increase an average transmit power for a same peak transmit power.

10. A system as in claim 9, further comprising an interleaver that interleaves the symbols for transmission in groups of subcarrier frequencies so as to modify the amount of symbol permutations.

11. A system as in claim 10, wherein the transmitter transmits symbols from the same symbol alphabets on different groups of subcarrier frequencies.

12. A system as in claim 9, wherein said transmitter comprises a single input single output transmitter or a multiple input multiple output transmitter.

13. A system as in claim 12, wherein the transmitter transmits the symbols using orthogonal frequency division multiplexing.

14. The system as in claim 9, wherein the peak-to-average-power ratio reduction algorithm searches the transmit carrier frequencies successively a predetermined number of times to find a transmit sequence that results in a minimum peak to average power ratio.

15. The system as in claim 9, wherein the peak-to-average-power ratio reduction algorithm selects a transmit sequence of scrambled signals assigned to subcarriers so as to provide an increased transmit power over the transmit subcarrier frequencies.
